(19) United States
(12) Patent Application Publication
(10) Pub. No.: US 2014/0227502 A1
(43) Pub. Date: Aug. 14, 2014

(54) PRESSURE-SENSITIVE ADHESIVE LAYER FOR OPTICAL USE, PRESSURE-SENSITIVE ADHESIVE SHEET, OPTICAL COMPONENT AND TOUCH PANEL

(71) Applicant: NITTO DENKO CORPORATION, Ibaraki-shi (JP)

(72) Inventors: Hirofumi Katami, Ibaraki-shi (JP); Takahiro Nonaka, Ibaraki-shi (JP); Hiroaki Kishioka, Ibaraki-shi (JP)

(73) Assignee: NITTO DENKO CORPORATION, Ibaraki-shi (JP)

(21) Appl. No.: 14/172,141

(22) Filed: Feb. 4, 2014

(30) Foreign Application Priority Data
Feb. 14, 2013 (JP) 2013-026610
May 23, 2013 (JP) 2013-109424
May 23, 2013 (JP) 2013-109425
Dec. 26, 2013 (JP) 2013-269061

(51) Int. Cl. C09J 7/02; C08K 5/3475

(52) U.S. Cl. CPC C09J 7/0217; C08K 5/3475
USPC 428/220; 524/548; 524/91; 428/355 CN

(57) ABSTRACT

Provided are an optical component capable of suppressing the occurrence of undulations, having an excellent corrosion inhibition effect while maintaining a high level of adhesion reliability and transparency, as well as a pressure-sensitive adhesive layer and a pressure-sensitive adhesive sheet that can produce such an optical component efficiently and at a low cost. The present invention provides an optical pressure-sensitive adhesive layer comprising a base polymer and a rust inhibitor, characterized in that the base polymer does not or substantially does not contain an acid group-containing monomer as a constituent monomer component, and that an 85° C. modulus of elasticity is not less than 5.0×10⁴ Pa.

### TECHNICAL FIELD

The present invention relates to an optical pressure-sensitive adhesive layer, a pressure-sensitive adhesive layer, a pressure-sensitive adhesive sheet, an optical component, and a touch panel.

### BACKGROUND ART

Recently, display devices, such as a liquid crystal display (LCD), or input devices, such as a touch panel, are being widely used in various fields. When manufacturing such a display device or input device, a pressure-sensitive adhesive sheet is used for laminating an optical component. For example, a transparent pressure-sensitive adhesive sheet is used for the lamination of an optical component in various display devices, such as a touch panel.

These display devices and input devices suffer from the problem that their metal wiring corrodes due to the entry of moisture or acid gas, salt water, or a corrosive material from the external environment. With the recent increases in the size and narrowing in the frame of sensors, there are more examples of copper wiring being used. After silver, copper has the second best electrical conductivity, and is thus a useful material for wiring. However, copper is also known to be susceptible to oxidation and corrosion. To inhibit metal oxidation and corrosion, it is common to prevent the entry of moisture or a corrosive material by coating a moisture-proof protective layer on the metal wiring (Patent Literature 1).

### CITATION LIST

### Patent Literature

### Patent Literature 1

Japanese Patent Laid-Open No. 2011-28594

### SUMMARY OF INVENTION

### Technical Problem

However, the above-described coating needs to be carried out after the metal wiring has been provided, so that the number of processes is increased and extra work is required, which has been a large problem in terms of reducing the production yield and in terms of cost. Further, if a moisture-proof protective layer is used, there has been the problem of obtaining adhesion reliability, such as adhesion and resistance to foaming and release (property in which foaming and release are less susceptible to occurring at the interface between a pressure-sensitive adhesive sheet and an adherend under a high-temperature environment), and transparency.

Further, if a pattern is formed on a metal film in a laminate having a structure in which a metal film is laminated on a support, this results in portions where the pattern has been formed (a pattern-forming portion) and portions where the pattern has not been formed (a pattern-free portion). When such a metal film pattern is formed, undulations can occur in the laminate under a high-temperature environment due to a difference in the linear expansion coefficient between the material forming the support and the metal constituting the metal film. If such undulations occur, there tends to be the problem that the appearance deteriorates. This is because a step at the boundary between the pattern-forming portion and the pattern-free portion (hereinafter sometimes referred to as “pattern boundary”) tends to become larger than necessary, so that the pattern boundary tends to be more visible.

Therefore, it is an object of the present invention to provide an optical component (especially, an optical component having a pressure-sensitive adhesive sheet) that can suppress the occurrence of undulations under a high-temperature environment and has an excellent corrosion inhibition effect on metal wiring, such as copper wiring, while maintaining a high level of adhesion reliability, such as adhesion and an anti-foaming release property (property in which foaming and release are less susceptible to occurring at the interface between a pressure-sensitive adhesive sheet and an adherend under a high-temperature environment), and transparency, as well as an optical pressure-sensitive adhesive layer and pressure-sensitive adhesive sheet capable of producing such an optical component efficiently and at a low cost.

### Means for Solving the Problems

Accordingly, as a result of diligent research into solving the above-described problems, the present inventors discovered that adhesion reliability, transparency, and an corrosion inhibition effect could be obtained by using a suitable base polymer as the base polymer forming the pressure-sensitive adhesive layer, and using a rust inhibitor, and also discovered that the occurrence of undulations under a high-temperature environment can be suppressed by controlling the modulus of elasticity in the pressure-sensitive adhesive composition during high temperatures, thereby completing the present invention.

Especially, the present inventors discovered that by using a monomer component that does not or substantially does not contain an acid group-containing monomer as the monomer component forming a base polymer, and using a rust inhibitor, a synergistic action could be obtained for the corrosion inhibition effect, thereby completing the present invention.

Specifically, the present invention provides an optical pressure-sensitive adhesive layer comprising a base polymer and a rust inhibitor, characterized in that the base polymer does not or substantially does not contain an acid group-containing monomer as a constituent monomer component, and that an 85° C. modulus of elasticity is not less than 5.0×10⁴ Pa.

In addition, the present invention provides an optical pressure-sensitive adhesive layer comprising an acrylic polymer (A) as a main component and a rust inhibitor, characterized in that the acrylic polymer (A) does not or substantially does not contain a carboxyl group-containing monomer as a constituent monomer component, and that an 85° C. modulus of elasticity is not less than 5.0×10⁴ Pa.

It is preferred that the above-described optical pressure-sensitive adhesive layer comprises not less than 5 parts by weight of a hydroxyl group-containing monomer based on a total amount (100 parts by weight) of the monomer component forming acrylic polymer (A).

It is preferred that the above-described optical pressure-sensitive adhesive layer comprises not less than 5 parts by weight of a nitrogen atom-containing monomer based on a total amount (100 parts by weight) of the monomer component forming acrylic polymer (A).

It is preferred that the above-described rust inhibitor is a benzotriazole-based compound.

It is preferred that in the above-described optical pressure-sensitive adhesive layer, haze (based on JIS K7136) is not more than 1.0%.

It is preferred that in the above-described optical pressure-sensitive adhesive layer, total light transmittance (based on JIS K7361-1) is not less than 90%.

Further, the present invention provides a pressure-sensitive adhesive sheet having the above-described optical pressure-sensitive adhesive layer.

It is preferred that the above-described pressure-sensitive adhesive sheet has a 180° peel adhesive strength to a glass plate of not less than 8 N/20 mm.

It is preferred that the above-described pressure-sensitive adhesive sheet has a thickness of 12 to 350 μm.

In addition, the present invention provides an optical component comprising at least the above-described pressure-sensitive adhesive sheet and a base material, wherein the base material includes metal wiring on at least one face, and the pressure-sensitive adhesive sheet is attached onto a face on the side of the base material having the metal wiring.

It is preferred that in the above-described optical component, the metal wiring is copper wiring.

Still further, the present invention provides a touch panel comprising at least the above-described pressure-sensitive adhesive sheet and a base material, wherein the base material includes metal wiring on at least one face, and the pressure-sensitive adhesive sheet is attached onto a face on the side of the base material having the metal wiring.

It is preferred that in the above-described touch panel, the metal wiring is copper wiring.

### Advantageous Effects of Invention

Since the optical pressure-sensitive adhesive layer according to the present invention has adhesion reliability, transparency, and an corrosion inhibition effect, an optical component can be obtained that has an excellent corrosion inhibition effect on metal wiring, such as copper wiring, while maintaining a high level of adhesion reliability, such as adhesion and resistance to foaming and release, and transparency, as well as a pressure-sensitive adhesive layer and a pressure-sensitive adhesive sheet capable of producing such an optical component can be obtained. Further, by conferring a corrosion inhibition capability to a pressure-sensitive adhesive layer, a protective layer does not need to be coated, so that the number of processes can be reduced. Consequently, costs are decreased and yield is improved.

In addition, since the optical pressure-sensitive adhesive layer according to the present invention can suppress the occurrence of undulations under a high-temperature environment, an optical component having a good appearance, and a pressure-sensitive adhesive layer and pressure-sensitive adhesive sheet capable of producing such an optical component can be obtained.

### BRIEF DESCRIPTION OF DRAWINGS

FIG. 1 is a series of schematic diagrams illustrating specific examples of preferred embodiments of an optical component according to the present invention.

FIG. 2 is a series of schematic diagrams illustrating specific examples of preferred embodiments of a touch panel according to the present invention.

FIG. 3 is a top plan view of a glass with a step used in evaluation of resistance to foaming and release.

FIG. 4 is a cross-sectional view (cross-sectional view along the line A-A′) of the above glass with a step.

FIG. 5 is a cross-sectional view (cross-sectional view along the line B-B′) of the above glass with a step.

FIG. 6 is a cross-sectional schematic view illustrating an example of a laminate, in which undulations have occurred, that includes a support and a metal film.

FIG. 7 is a schematic plan view illustrating an example of a metal wiring pattern.

### DESCRIPTION OF EMBODIMENTS

### [1. Optical Pressure-Sensitive Adhesive Layer]

The optical pressure-sensitive adhesive layer according to the present invention is not especially limited, as long as it contains a base polymer as a main component and a rust inhibitor, in which the base polymer does not or substantially does not contain an acid group-containing monomer as a constituent monomer component, and an 85° C. modulus of elasticity is not less than 5.0×10⁴ Pa. Further, the pressure-sensitive adhesive composition according to the present invention contains at least a base polymer and a rust inhibitor.

Since the optical pressure-sensitive adhesive layer according to the present invention does not, or substantially does not, contain an acid group-containing monomer as a monomer component forming the base polymer, and further contains a rust inhibitor, a synergistic effect can be obtained regarding a corrosion inhibition effect, so that the optical pressure-sensitive adhesive layer has an excellent corrosion inhibition effect.

Further, the optical pressure-sensitive adhesive layer according to the present invention may be an optical pressure-sensitive adhesive layer that contains an acrylic polymer (A) as a main component and a rust inhibitor, in which the acrylic polymer (A) does not or substantially does not contain a carboxyl group-containing monomer as a constituent monomer component, and an 85° C. modulus of elasticity is not less than 5.0×10⁴ Pa.

The composition (pressure-sensitive adhesive composition, precursor composition) forming the optical pressure-sensitive adhesive layer according to the present invention can be in any form. Examples include an emulsion type, a solvent type, a hot-melt type, and an active energy ray-curable type. In the present specification, pressure-sensitive adhesive composition means a composition forming a pressure-sensitive adhesive layer, which includes a composition forming a pressure-sensitive adhesive.

Examples of the above-described base polymer comprised in the optical pressure-sensitive adhesive layer according to the present invention include, but are not especially limited to, an acrylic polymer contained in an acrylic pressure-sensitive adhesive layer as the base polymer, a rubber-based polymer contained in a rubber-based pressure-sensitive adhesive layer (a natural rubber-based pressure-sensitive adhesive layer, a synthetic rubber-based pressure-sensitive adhesive layer etc.) as the base polymer, a silicon-based polymer contained in a silicon-based pressure-sensitive adhesive layer as the base polymer, a polyester-based polymer contained in a polyester-based pressure-sensitive adhesive layer as the base polymer, a urethane-based polymer contained in a urethane-based pressure-sensitive adhesive layer as the base polymer, a polyamide-based polymer containing a polyamide-based pressure-sensitive adhesive layer as the base polymer, an epoxy-based polymer containing an epoxy-based pressure-sensitive adhesive layer as the base polymer, a vinyl alkyl ether-based polymer contained in a vinyl alkyl ether-based pressure-sensitive adhesive layer as the base polymer, and a fluoropolymer contained in a fluorine-based pressure-sensitive adhesive layer as the base polymer. Among these, from perspectives such as transparency, weatherability, adhesion reliability, and ease of designing the functions of the pressure-sensitive adhesive layer due to the wide availability of types of monomer, it is preferred that the above-described base polymer is an acrylic polymer. Specifically, it is preferred that the above-described optical pressure-sensitive adhesive layer according to the present invention is an acrylic pressure-sensitive adhesive layer that contains the below-described acrylic polymer (A) as the base polymer. The base polymers can be used singly or in combinations of two or more.

Although the content of the base polymer in the above-described optical pressure-sensitive adhesive layer according to the present invention is not especially limited, it is preferably not less than 75 wt. % (e.g., 75 to 99.9 wt. %), and more preferably not less than 85 wt. % (e.g., 85 to 99.9 wt. %).

The above-described optical pressure-sensitive adhesive layer according to the present invention does not or substantially does not contain an acid group-containing monomer (e.g., a carboxyl group-containing monomer, a sulfo group-containing monomer, a phosphate group-containing monomer). Consequently, the pressure-sensitive adhesive layer can obtain an excellent corrosion inhibition effect on metal wiring. Moreover, the pressure-sensitive adhesive layer can be said to substantially not contain an acid group-containing monomer if the content of the acid group-containing monomer is, based on the above-described optical pressure-sensitive adhesive layer according to the present invention, preferably not more than 0.05 wt. % (e.g., 0 to 0.05 wt. %), more preferably not more than 0.01 wt. % (e.g., 0 to 0.01 wt. %), and even more preferably not more than 0.001 wt. % (e.g., 0 to 0.001 wt. %).

If the above-described optical pressure-sensitive adhesive layer according to the present invention is an acrylic pressure-sensitive adhesive layer, the pressure-sensitive adhesive layer does not or substantially does not contain an acid group-containing monomer, such as a carboxyl group-containing monomer, as the monomer component forming the acrylic polymer contained as the base polymer. If the above-described optical pressure-sensitive adhesive layer according to the present invention contains an acrylic polymer (A) as the base polymer, it is preferred that the pressure-sensitive adhesive layer does not or substantially does not contain a carboxyl group-containing monomer as the monomer component forming the acrylic polymer (A). Consequently, the above-described optical pressure-sensitive adhesive layer according to the present invention can obtain an excellent corrosion inhibition effect. Regarding the meaning of carboxyl group-containing monomer, the meaning of “substantially does not contain”, the monomer having an acid group other than a carboxyl group and the like, these are the same as for the monomer component forming the acrylic polymer (A). In addition, the optical pressure-sensitive adhesive layer according to the present invention can be said to substantially not contain a carboxyl group-containing monomer if the content of the carboxyl group-containing monomer is, based on the total amount of the above-described pressure-sensitive adhesive layer, preferably not more than 0.05 wt. % (e.g., 0 to 0.05 wt. %), more preferably not more than 0.01 wt. % (e.g., 0 to 0.01 wt. %), and even more preferably not more than 0.001 wt. % (e.g., 0 to 0.001 wt. %).

The above-described optical pressure-sensitive adhesive layer according to the present invention is transparent, or has a transparency. Consequently, visibility and appearance through the optical pressure-sensitive adhesive layer according to the present invention are excellent.

Although the haze (based on JIS K7136) of the above-described optical pressure-sensitive adhesive layer according to the present invention is not especially limited, it is preferably not more than 1.0%, and more preferably not more than 0.8%. It is preferred for the haze to be not more than 1.0%, because excellent transparency and excellent appearance are obtained. This haze can be measured using a haze meter (trade name “HM-150”, manufactured by Murakami Color Research Laboratory Co., Ltd.) by, for example, employing a specimen obtained by leaving a pressure-sensitive adhesive layer (thickness 100 μm) for at least 24 hours in an ordinary state (23° C., 50% RH), then laminating the pressure-sensitive adhesive layer on a slide glass (e.g., having a total light transmittance of 91.8% and a haze of 0.4%).

Although the total light transmittance (based on JIS K7361-1) of the above-described optical pressure-sensitive adhesive layer according to the present invention in the visible light wavelength region is not especially limited, it is preferably not less than 85%, and more preferably not less than 88%. It is preferred for the total light transmittance to be not less than 85%, because excellent transparency and excellent appearance are obtained. Further, this total light transmittance can be measured using a haze meter (trade name “HM-150”, manufactured by Murakami Color Research Laboratory Co., Ltd.) by, for example, employing a specimen obtained by leaving a pressure-sensitive adhesive layer (thickness 100 μm) for at least 24 hours in an ordinary state (23° C., 50% RH), then peeling off a separator if there is one, and laminating the pressure-sensitive adhesive layer on a slide glass (e.g., having a total light transmittance of 91.8% and a haze of 0.4%).

The 85° C. modulus of elasticity of the optical pressure-sensitive adhesive layer according to the present invention is not less than 5.0×10⁴ Pa, more preferably not less than 7.0×10⁴ Pa, and even more preferably not less than 9.0×10⁴ Pa. Since the optical pressure-sensitive adhesive layer according to the present invention has an 85° C. modulus of elasticity of not less than 5.0×10⁴ Pa, the occurrence of undulations can be suppressed. Consequently, according to the optical pressure-sensitive adhesive layer according to the present invention, an optical component or a touch panel having a good appearance can be obtained. This is because the occurrence of so-called “patterning” (a phenomenon in which the pattern boundary tends to be more visible because a step at the pattern boundary is larger than necessary, which causes appearance to deteriorate) can be suppressed.

The 85° C. modulus of elasticity can be measured as follows. A measurement sample is obtained by punching a pressure-sensitive adhesive layer (thickness: about 2 mm) into a diameter of 7.9 mm and producing a cylindrical pellet. The measurement sample is fixed in a jig having parallel plates at a diameter of 7.9 mm, and the temperature dependence of a storage elastic modulus G′ is measured with a dynamic viscoelasticity measurement apparatus (ARES, manufactured by Rheometric Scientific, Inc.). Specifically, this is the storage elastic modulus (G′) at 85° C. when measurement is performed in shear mode, in a temperature range of −70° C. to 150° C., at a rate of temperature increase of 5° C./min, and a frequency of 1 Hz.

Regarding the above-described undulations, FIG. 6 is a cross-sectional schematic view illustrating an example of a laminate, in which undulations have occurred, that includes a support and a metal film (a laminate having a metal film pattern on a support). In FIG. 6, reference numeral 6 denotes a laminate, reference numeral 61 denotes a support, and reference numeral 62 denotes a metal film (metal film pattern). Thus, the term “undulations” refers to surges or ripples.

The method for producing the above-described optical pressure-sensitive adhesive layer is not especially limited. For example, the pressure-sensitive adhesive layer can be produced by producing the above-described optical pressure-sensitive adhesive layer, and optionally performing treatments such as irradiating an active energy ray, and heating and drying. A specific example includes producing the pressure-sensitive adhesive layer by admixing a rust inhibitor (e.g., the below-described benzotriazole-based compound), and optionally additives and the like with a polymerizable monomer mixture or a partially polymerized product thereof.

The optical pressure-sensitive adhesive layer according to the present invention contains a rust inhibitor. The rust inhibitor includes a compound that inhibits rust or corrosion of metal. Examples of the rust inhibitor include, but are not especially limited to, amine compounds, benzotriazole-based compounds, and nitrites. Further examples include ammonium benzoate, ammonium phthalate, ammonium stearate, ammonium palmitate, ammonium oleate, ammonium carbonate, dicyclohexylamine benzoate, urea, urotropine, thiourea, phenyl carbamate, and cyclohexyl ammonium-N-cyclohexyl carbamate (CHC). The rust inhibitors can be used singly or in combinations of two or more.

Examples of the above amine compound include hydroxy group-containing amine compounds, such as 2-amino-2-methyl-1-propanol, monoethanolamine, monoisopropanolamine, diethylethanolamine, ammonia, and ammonia water; cyclic amines, such as morpholine; cyclic alkylamine compounds, such as cyclohexylamine; and straight-chain alkyl amines, such as 3-methoxypropylamine. Further, examples of the nitrite include dicyclohexyl ammonium nitrite (DICHAN), disopropyl ammonium nitrite (DIPAN), sodium nitrite, potassium nitrite, and calcium nitrite.

Among these, from the perspectives of compatibility with the base polymer and transparency, if further reacting the base polymer after addition, it is preferred that the above-described rust inhibitor is a benzotriazole-based compound because a benzotriazole-based compound is less susceptible to inhibiting the base polymer reactions (cross-linking, polymerization and the like).

Although the content of the above-described rust inhibitor is not especially limited, it is preferably 0.02 to 15 parts by weight based on 100 parts by weight of the base polymer. It is preferred that the content is not less than 0.02 parts by weight, because a good corrosion inhibition performance tends to be obtained. On the other hand, it is preferred that the content is less than 15 parts by weight, because transparency and adhesion reliability, such as resistance to foaming and release, tend to be obtained.

Especially from the perspective of enabling adhesion reliability, transparency, and a corrosion inhibition property to be obtained in a good balance and at a high level, it is preferred that the above-described base polymer is an acrylic polymer (especially, the below-described acrylic polymer (A)), and that the above-described rust inhibitor is a benzotriazole-based compound. Specifically, it is preferred that the above-described optical pressure-sensitive adhesive layer according to the present invention is an acrylic pressure-sensitive adhesive layer containing at least an acrylic polymer (especially, the below-described acrylic polymer (A)) as the base polymer, and a benzotriazole-based compound as the rust inhibitor.

### [1-1. Benzotriazole-Based Compound]

Although the content of the benzotriazole-based compound is not especially limited, based on the total amount (100 parts by weight) of the monomer component forming the acrylic polymer (A), the content is preferably 0.02 to 3 parts by weight, more preferably 0.02 to 2.5 parts by weight, and even more preferably 0.02 to 2 parts by weight. Specifically, it is preferred that the above-described optical pressure-sensitive adhesive layer according to the present invention includes, based on 100 parts by weight of the acrylic polymer (A), 0.02 to 3 parts by weight, more preferably 0.02 to 2.5 parts by weight, and even more preferably 0.02 to 2 parts by weight, of the benzotriazole-based compound. If the amount of the benzotriazole-based compound is too low, it may not be possible for the value of the sheet resistivity rate of change T to be less than the predetermined value. Further, since the amount of the benzotriazole-based compound is not more than a predetermined level, adhesion reliability, such as resistance to foaming and release, can be reliably obtained, and an increase in the haze of the pressure-sensitive adhesive layer or pressure-sensitive adhesive sheet can also be reliably prevented.

Although the above-described benzotriazole-based compound is not especially limited as long as it is a compound having a benzotriazole skeleton, from the perspective of obtaining a better corrosion inhibition effect, it is preferred that the benzotriazole-based compound has a structure represented by the following formula (1).

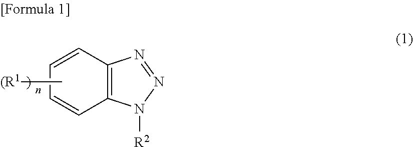

(In formula (1) R¹ and R² may be the same or different, R¹ represents a substituent on the benzene ring, such as an alkyl group having 1 to 6 carbon atoms, an alkoxy group having 1 to 6 carbon atoms, an aryl group having 6 to 14 carbon atoms, an amino group, a mono- or di-C₁₋₁₀alkylamino group, an amino-C₁₋₆alkyl group, a mono- or di-C₁₋₁₀alkylamino-C₁₋₆alkyl group, a mercapto group, an alkoxycarbonyl group having 1 to 6 carbon atoms, and n represents an integer of 0 to 4. If n is not less than 2, n R¹s may be the same or different. R² represents a substituent such as a hydrogen atom, an alkyl group having 1 to 12 carbon atoms, an alkoxy group having 1 to 12 carbon atoms, an aryl group having 6 to 14 carbon atoms, an amino group, a mono- or di-C₁₋₁₀alkylamino group, an amino-C₁₋₆alkyl group, a mono- or di-C₁₋₁₀alkylamino-C₁₋₆alkyl group, a mercapto group, an alkoxycarbonyl group having 1 to 12 carbon atoms.)

From the perspective of obtaining a better corrosion inhibition effect, R¹ is preferably an alkyl group, an alkoxycarbonyl group and the like having 1 to 3 carbon atoms, and a methyl group and the like is more preferable. Further, n is preferably 0 or 1.

From the same perspective, R² is preferably a hydrogen atom, a mono- or di-C₁₋₁₀alkylamino-C₁₋₆alkyl group and the like, and a hydrogen atom, a di-C₁₋₈alkylamino-C₁₋₄alkyl group and the like are more preferable.

### [1-2. Acrylic Polymer (A)]

It is preferred that the above-described optical pressure-sensitive adhesive layer according to the present invention is an acrylic pressure-sensitive adhesive layer having the acrylic polymer (A) as a main component. Although the specific content of the acrylic polymer (A) is not especially limited, it is preferably not less than 75 wt. % (e.g., 75 to 99.9 wt. %), and more preferably not less than 85 wt. % (e.g., 85 to 99.9 wt. %), based on the total amount of the above-described optical pressure-sensitive adhesive layer according to the present invention (total weight, 100 wt. %).

Examples of the pressure-sensitive adhesive composition forming the optical pressure-sensitive adhesive layer containing the acrylic polymer (A) as a main component include, but are not especially limited to, a composition having the acrylic polymer (A) as an essential component; and a composition having a mixture of the monomer component forming the acrylic polymer (A) (sometimes referred to as “monomer mixture”) or a partially polymerized product thereof as an essential component. Examples of the former may include, but are not especially limited to, a so-called solvent-based composition. Examples of the latter may include a so-called active energy ray-curable type composition. The pressure-sensitive adhesive composition can optionally include other additives.

The above “monomer mixture” includes cases in which the mixture is formed from a single monomer component and cases in which the mixture is formed from two or more monomer components. Further, the above “partially polymerized product” means a composition obtained by partially polymerizing one or two or more of the constituent components of the monomer mixture. Of these, it is preferred that the above-described pressure-sensitive adhesive composition is a composition having a monomer mixture or a partially polymerized product thereof as an essential component.

The acrylic polymer (A) is a polymer that includes an acrylic monomer as an essential monomer unit (monomer constituent unit). In other words, the acrylic polymer (A) is a polymer that includes a constituent unit derived from an acrylic monomer as a constituent unit. Specifically, the acrylic polymer (A) is a polymer that is constituted (formed) from an acrylic monomer as an essential monomer component. In the present specification, “(meth)acrylic” represents either one or both of “acrylic” and “methacrylic”. This is the same for other cases as well. Although the weight average molecular weight of the acrylic polymer (A) is not especially limited, it is preferably 100,000 to 5,000,000.

It is preferred that the acrylic polymer (A) is a polymer that includes an alkyl(meth)acrylate having a straight-chain or branched alkyl group (hereinafter sometimes simply referred to as “alkyl(meth)acrylate”) as an essential monomer unit.

Examples of the above alkyl(meth)acrylate include alkyl(meth)acrylates whose alkyl group has 1 to 20 carbon atoms, such as methyl(meth)acrylate, ethyl(meth)acrylate, propyl(meth)acrylate, isopropyl(meth)acrylate, butyl(meth)acrylate (n-butyl(meth)acrylate), isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, isostearyl(meth)acrylate, nonadecyl(meth)acrylate, and eicosyl(meth)acrylate. The alkyl(meth)acrylates can be used singly or in combinations of two or more.

Among these, from the perspective of obtaining strong adhesion and the perspective of adjusting the residual stress, the above-described alkyl(meth)acrylate is preferably an alkyl(meth)acrylate whose alkyl group has 1 to 18 carbon atoms, and more preferably is methyl methacrylate (MMA), butyl acrylate (BA), 2-ethylhexyl acrylate (2EHA), or isostearyl acrylate (ISTA).

Although the content (ratio) of the above-described alkyl(meth)acrylate in all the monomer units of the acrylic polymer (A) (the total amount of the monomer component forming the acrylic polymer (A)) is not especially limited, from the perspective of adhesion reliability, and especially adhesion reliability at low-temperatures, the content is preferably 30 to 95 parts by weight, more preferably 35 to 90 parts by weight, and even more preferably 40 to 85 parts by weight, based on the total amount (100 parts by weight) of the monomer component forming the acrylic polymer (A).

In addition to the above-described alkyl(meth)acrylate as a monomer unit, the acrylic polymer (A) may also include a monomer that can be copolymerized (a copolymerizable monomer). Specifically, the acrylic polymer (A) may include a copolymerizable monomer as a constituent monomer component. The copolymerizable monomers can be used singly or in combinations of two or more.

Preferred examples of the above copolymerizable monomer include a hydroxyl group-containing monomer. If the acrylic polymer (A) includes a hydroxyl group-containing monomer as a monomer unit, polymerization occurs more easily when polymerizing the constituent monomer component, and it is easier to obtain good cohesion. Consequently, it is easier to obtain strong adhesion, and to increase the gel fraction, which makes it easier to obtain an excellent resistance to foaming and release. In addition, it is easier to suppress whitening of the pressure-sensitive adhesive sheet, which can occur under a high-humidity environment.

The content (ratio) of the above-described hydroxyl group-containing monomer based on the total amount (100 parts by weight) of the monomer component forming the acrylic polymer (A) is not especially limited. If the amount of the hydroxyl group-containing monomer is not less than a predetermined level, whitening of the pressure-sensitive adhesive sheet, which can occur under a high-humidity environment, can be better suppressed, and transparency, such as humid cloudiness resistance, can be obtained. A lower limit for the content of the hydroxyl group-containing monomer is preferably not less than 5 parts by weight, more preferably not less than 7 parts by weight, and even more preferably not less than 10 parts by weight. Further, an upper limit for the content of the hydroxyl group-containing monomer is, from the perspectives of cohesion and easily obtaining adhesion reliability, such as adhesion and resistance to foaming and release, preferably not more than 40 parts by weight, more preferably not more than 35 parts by weight, and even more preferably not more than 30 parts by weight.

In addition, a preferred example of the above-described copolymerizable monomer is a nitrogen atom-containing monomer. If the acrylic polymer (A) includes a nitrogen atom-containing monomer as a monomer unit, a suitable cohesion tends to be obtained. Consequently, the 180° peel adhesive strength to a glass plate and the 180° peel adhesive strength to an acrylic plate tend to increase, so that a strong adhesion tends to be obtained. Further, the gel fraction tends to increase, which makes it easier to obtain an excellent resistance to foaming and release. In addition, a suitable flexibility for the pressure-sensitive adhesive layer tends to be obtained, so that by adjusting the 300% tension residual stress to within a specific range, an excellent stress relaxation property and excellent step conformability tend to be obtained.

Although the content (ratio) of the above-described nitrogen atom-containing monomer based on the total amount (100 parts by weight) of the monomer component forming the acrylic polymer (A) is not especially limited, it is preferably not less than 5 parts by weight. A lower limit for the content of the nitrogen atom-containing monomer is, from the perspectives of cohesion, adhesion, and resistance to foaming and release, more preferably not less than 7 parts by weight, and even more preferably not less than 10 parts by weight, based on the total amount (100 parts by weight) of the monomer component forming the acrylic polymer (A). Further, an upper limit for the content of the nitrogen atom-containing monomer is, from the perspective of more easily obtaining suitable flexibility for the pressure-sensitive adhesive layer, an excellent stress relaxation property, and excellent step conformability, preferably not more than 40 parts by weight, more preferably not more than 35 parts by weight, and even more preferably not more than 30 parts by weight.

The above-described acrylic polymer (A) can be obtained by polymerizing the above-described monomer unit (monomer component) by a known or customary polymerization method. Examples of the method for polymerizing the above-described acrylic polymer (A) include solution polymerization, emulsion polymerization, bulk polymerization, and polymerization by irradiating with an active energy ray (active energy ray polymerization). Among these, from perspectives such as the transparency of the pressure-sensitive adhesive layer, moisture resistance, and cost, solution polymerization and active energy ray polymerization are preferred, and more preferred is active energy ray polymerization.

Examples of the active energy ray irradiated during the above-described active energy ray polymerization (photopolymerization) include ionizing radiation, such as α-rays, β-rays, γ-rays, neutron rays, and an electron ray, and UV-rays. UV-rays are especially preferred. Further, the irradiation energy, the irradiation time, the irradiation method and the like of the active energy ray are not especially limited, as long as a monomer component reaction is made to occur by activating a photopolymerization initiator.

Various kinds of common solvents may be used during the polymerization of the above-described acrylic polymer (A). Examples of such solvents include organic solvents, for instance esters, such as ethyl acetate and n-butyl acetate; aromatic hydrocarbons, such as toluene and benzene; aliphatic hydrocarbons, such as n-hexane and n-heptane; alicyclic hydrocarbons, such as cyclohexane and methylcyclohexane; and ketones, such as methyl ethyl ketone and methyl isobutyl ketone. The solvents can be used singly or in combinations of two or more.

Further, during polymerization of the acrylic polymer (A), a polymerization initiator, such as a thermal polymerization initiator and a photopolymerization initiator (photoinitiator) may be used based on the type of polymerization reaction. The polymerization initiators can be used singly or in combinations of two or more.

Examples of the above-described photopolymerization initiator include, but are not especially limited to, a benzoin ether photopolymerization initiator, an acetophenone photopolymerization initiator, an α-ketol photopolymerization initiator, an aromatic sulfonyl chloride photopolymerization initiator, an optically-active oxime-based photopolymerization initiator, a benzoin-based photopolymerization initiator, a benzyl-based photopolymerization initiator, a benzophenone photopolymerization initiator, a ketal-based photopolymerization initiator, and a thioxanthone photopolymerization initiator. The photopolymerization initiators can be used singly or in combinations of two or more.

Examples of the above benzoin ether photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the above acetophenone photopolymerization initiator include 2,2-diethoxyacetophenone, 2,2-dimethoxy-2-phenylacetophenone, 1-hydroxycyclohexylphenyl ketone, 4-phenoxydichloroacetophenone, and 4-(t-butyl)dichloroacetophenone. Examples of the above α-ketol photopolymerization initiator include 2-methyl-2-hydroxypropiophenone and 1-[4-(2-hydroxyethyl)phenyl]-2-methyl propan-1-one. Examples of the aromatic sulfonyl chloride photopolymerization initiator include 2-naphthalenesulfonyl chloride. Examples of the optically-active oxime-based photopolymerization initiator include 1-phenyl-1,1-propanedion-2-(o-ethoxycarbonyl)-oxime. Examples of the benzoin-based photopolymerization initiator include benzoin. Examples of the benzyl-based photopolymerization initiator include benzyl. Examples of the benzophenone photopolymerization initiator include benzophenone, benzoyl benzoic acid, 3,3′-dimethyl-4-methoxybenzophenone, polyvinyl benzophenone, and α-hydroxycyclohexyl phenyl ketone. Examples of the ketal-based photopolymerization initiator include benzyl dimethyl ketal. Examples of the thioxanthone photopolymerization initiator include thioxanthone, 2-chlorothioxanthone, 2-methylthioxanthone, 2,4-dimethylthioxanthone, isopropylthioxanthone, and 2,4-diisopropylthioxanthone, dodecylthioxanthone.

Although the amount of the above-described photopolymerization initiator used is not especially limited, for example, the amount used is, based on 100 parts by weight of all the monomer units of the acrylic polymer (A) (total amount of the monomer component forming the acrylic polymer (A)), preferably 0.001 to 1 part by weight, and more preferably 0.01 to 0.50 parts by weight.

Examples of the above-described thermal polymerization initiator include, but are not especially limited to, an azo polymerization initiator, a peroxide polymerization initiator (e.g., dibenzoyl peroxide, tert-butyl permaleate), and a redox polymerization initiator. Among these, an azo polymerization initiator disclosed in Japanese Patent Laid-Open No. 2002-69411 is preferred. Examples of the azo polymerization initiator include 2,2′-azobisisobutyronitrile (hereinafter sometimes referred to as “AIBN”), 2,2′-azobis-2-methylbutyronitrile (hereinafter sometimes referred to as “AMBN”), dimethyl 2,2′-azobis(2-methylpropionate), and 4,4′-azobis-4-cyano valeric acid.

Although the amount of the above-described thermal polymerization initiator used is not especially limited, for example, for the above-described azo polymerization initiator, the amount used is, based on 100 parts by weight of all the monomer units of the acrylic polymer (A) (total amount of the monomer component forming the acrylic polymer (A)), preferably 0.05 to 0.5 parts by weight, and more preferably 0.1 to 0.3 parts by weight.

### [1-3. Carboxyl Group-Containing Monomer Etc.]

The above-described optical pressure-sensitive adhesive layer according to the present invention does not or substantially does not contain an acid group-containing monomer as the monomer component forming the base polymer. If the above-described optical pressure-sensitive adhesive layer according to the present invention is an acrylic pressure-sensitive adhesive layer, it is preferred that the optical pressure-sensitive adhesive layer according to the present invention substantially does not contain a carboxyl group-containing monomer as the monomer component forming the acrylic polymer (A). “Substantially does not contain” excludes cases in which such a carboxyl group-containing monomer is inevitably included, and refers to not actively adding such a monomer. Further, a carboxyl group-containing monomer means a monomer having at least one carboxyl group in the molecule. From the perspective that a better corrosion inhibition effect can be obtained, specifically, the pressure-sensitive adhesive layer can be said to substantially not contain a carboxyl group-containing monomer if the content is, based on the total amount (100 parts by weight) of the monomer component forming the acrylic polymer (A), preferably not more than 0.05 parts by weight (e.g., 0 to 0.05 parts by weight), more preferably not more than 0.01 parts by weight (e.g., 0 to 0.01 parts by weight), and even more preferably not more than 0.001 parts by weight (e.g., 0 to 0.001 parts by weight). Further, examples of the above-described carboxyl group-containing monomer include (meth)acrylic acid, itaconic acid, maleic acid, fumaric acid, crotonic acid, and isocrotonic acid. In addition, the above-described carboxyl group-containing monomer may include, for example, an acid anhydride group-containing monomer, such as maleic anhydride and itaconic anhydride.

Further, if the above-described optical pressure-sensitive adhesive layer according to the present invention is an acrylic pressure-sensitive adhesive layer, from the perspective that a better corrosion inhibition effect can be obtained, it is preferred that the optical pressure-sensitive adhesive layer according to the present invention not only substantially does not contain a carboxyl group-containing monomer as the monomer component forming the acrylic polymer (A), but also that the pressure-sensitive adhesive layer substantially does not contain a monomer having an acid group other than a carboxyl group (e.g., a sulfo group, a phosphate group) as the monomer component forming the acrylic polymer (A). Namely, it is preferred that the acrylic polymer (A) does not substantially contain either a carboxyl group-containing monomer or a monomer having another acid group as the constituent monomer component. Specifically, the pressure-sensitive adhesive layer can be said to substantially not contain a carboxyl group-containing monomer or another acid group-containing monomer if the total amount of the carboxyl group-containing monomer and the monomer having another acid group as the monomer component forming the acrylic polymer (A) is, based on the total amount (100 parts by weight) of the monomer component forming the acrylic polymer (A), preferably not more than 0.05 parts by weight (e.g., 0 to 0.05 parts by weight), more preferably not more than 0.01 parts by weight (e.g., 0 to 0.01 parts by weight), and even more preferably not more than 0.001 parts by weight (e.g., 0 to 0.001 parts by weight).

In addition, from the same perspective, it is preferred that the above-described optical pressure-sensitive adhesive layer according to the present invention does not or substantially does not contain an acid group-containing monomer as a monomer component even as the monomer component forming a polymer other than the acrylic polymer (A) (e.g., the below-described acrylic polymer (B)). For example, it is preferred that the pressure-sensitive adhesive layer substantially does not contain a carboxyl group-containing monomer. Regarding the meaning of “substantially does not contain”, the preferred level, the monomer having an acid group other than a carboxyl group and the like, these are the same as for the monomer component forming the acrylic polymer (A).

### [1-4. Basic Group-Containing Monomer]

It is preferred that the above-described optical pressure-sensitive adhesive layer according to the present invention does not or substantially does not contain a basic group-containing monomer as the monomer component forming the base polymer. For example, if the above-described optical pressure-sensitive adhesive layer according to the present invention is an acrylic pressure-sensitive adhesive layer containing the acrylic polymer (A) as a base polymer, it is preferred that the pressure-sensitive adhesive layer substantially does not contain a basic group-containing monomer as the monomer component forming a polymer other than the acrylic polymer (A). The point that it is preferred that the pressure-sensitive adhesive layer substantially does not contain a basic group-containing monomer even for a monomer component not forming various other polymers is the same as for the case of the carboxyl group-containing monomer. Further, this is also the case for the meaning of “substantially does not contain”, the preferred level and the like.

### [1-5. Hydroxyl Group-Containing Monomer]

A hydroxyl group-containing monomer means a monomer having at least one hydroxyl group in the molecule. Further, a monomer having at least one hydroxyl group in the molecule and at least one carboxyl group in the molecule is considered here to be a carboxyl group-containing monomer, not a hydroxyl group-containing monomer. Examples of the hydroxyl group-containing monomer include, but are not especially limited to, specifically, hydroxyl group-containing (meth)acrylates, such as 2-hydroxyethyl(meth)acrylate, 2-hydroxypropyl(meth)acrylate, 2-hydroxybutyl(meth)acrylate, 3-hydroxypropyl(meth)acrylate, 4-hydroxybutyl(meth)acrylate, 6-hydroxyhexyl(meth)acrylate, hydroxyoctyl(meth)acrylate, hydroxydecyl(meth)acrylate, hydroxylauryl(meth)acrylate, (4-hydroxymethylcyclohexyl(meth)acrylate; vinyl alcohol and allyl alcohol. Among these, from the perspective of improving the compatibility of the benzotriazole-based compound, the above-described hydroxyl group-containing monomer is preferably a hydroxyl group-containing (meth)acrylate, and more preferably is 2-hydroxyethyl acrylate (HEA), 2-hydroxypropyl(meth)acrylate (HPA), and 4-hydroxybutyl acrylate (4HBA). The hydroxyl group-containing monomers can be used singly or in combinations of two or more.

### [1-6. Nitrogen Atom-Containing Monomer]

A nitrogen atom-containing monomer means a monomer having at least one nitrogen atom in the molecule (in one molecule). However, here, the nitrogen atom-containing monomer is not considered to be included in the above-described hydroxyl group-containing monomer. Specifically, in the present specification, a monomer that has a hydroxyl group and a nitrogen atom in the molecule is considered to be a nitrogen atom-containing monomer. Further, a monomer having at least one nitrogen atom in the molecule and at least one carboxyl group in the molecule is considered to be a carboxyl group-containing monomer, not a nitrogen atom-containing monomer.

From the perspective of improving resistance to foaming and release, the nitrogen atom-containing monomer is preferably an N-vinyl cyclic amide, a (meth)acrylamide and the like. The nitrogen atom-containing monomers can be used singly or in combinations of two or more.

From the perspective of improving the compatibility of the benzotriazole-based compound, the N-vinyl cyclic amide is preferably an N-vinyl cyclic amide represented by the following formula (2).

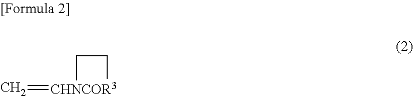

(In formula (2), R³ represents a divalent organic group.)

R³ in formula (2) represents a divalent organic group. Preferably, R³ is a divalent saturated hydrocarbon group or an unsaturated hydrocarbon group, and more preferably a divalent saturated hydrocarbon group (e.g., an alkylene group having 3 to 5 carbon atoms).

In addition, from the perspectives of improving resistance to foaming and release and the compatibility of the benzotriazole-based compound, the N-vinyl cyclic amide represented by the above formula (2) is preferably N-vinyl-2-pyrrolidone (NVP), N-vinyl-2-piperidone, N-vinyl-2-caprolactam, N,N-dimethyl(meth)acrylamide, N,N-diethyl(meth)acrylamide, N-vinyl-3-morpholinone, N-vinyl-1,3-oxazin-2-one, and N-vinyl-3,5-morpholinedione, more preferably N-vinyl-2-pyrrolidone, N-vinyl-2-caprolactam, N,N-dimethyl(meth)acrylamide, and N,N-diethyl(meth)acrylamide, and even more preferably N-vinyl-2-pyrrolidone.

Examples of the above-described (meth)acrylamide include (meth)acrylamide, N-alkyl(meth)acrylamide, and N,N-dialkyl(meth)acrylamide. Examples of the above-described N-alkyl(meth)acrylamide include N-ethyl(meth)acrylamide, N-isopropyl(meth)acrylamide, N-n-butyl(meth)acrylamide, and N-octyl acrylamide. Further, above-described N-alkyl(meth)acrylamide may be a (meth)acrylamide having an amino group, such as dimethylaminoethyl(meth)acrylamide, diethylaminoethyl(meth)acrylamide, and dimethylaminopropyl(meth)acrylamide. Examples of the above-described N,N-dialkyl(meth)acrylamide include N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide.

Further, the above-described (meth)acrylamide may also be, for example, various N-hydroxyalkyl(meth)acrylamides. Examples of such an N-hydroxyalkyl(meth)acrylamide include N-methylol(meth)acrylamide, N-(2-hydroxyethyl)(meth)acrylamide, N-(2-hydroxypropyl)(meth)acrylamide, N-(1-hydroxypropyl)(meth)acrylamide, N-(3-hydroxypropyl)(meth)acrylamide, N-(2-hydroxybutyl)(meth)acrylamide, N-(3-hydroxybutyl)(meth)acrylamide, N-(4-hydroxybutyl)(meth)acrylamide, and N-methyl-N-2-hydroxyethyl(meth)acrylamide.

In addition, the above-described (meth)acrylamide may also be, for example, various N-alkoxyalkyl(meth)acrylamides. Examples of such an N-alkoxyalkyl(meth)acrylamide include N-methoxymethyl(meth)acrylamide and N-butoxymethyl(meth)acrylamide.

Still further, examples of nitrogen atom-containing monomers other than the above-described N-vinyl cyclic amides and the above-described (meth)acrylamides include amino group-containing monomers, such as aminoethyl(meth)acrylate, dimethylaminoethyl(meth)acrylate, dimethylaminopropyl(meth)acrylate, and t-butylaminoethyl(meth)acrylate; cyano group-containing monomers, such as acrylonitrile and methacrylonitrile; heterocyclic ring-containing monomers, such as (meth)acryloyl morpholine, N-vinyl piperazine, N-vinyl pyrrole, N-vinyl imidazole, N-vinyl pyrazine, N-vinyl morpholine, N-vinyl pyrazole, vinyl pyridine, vinyl pyrimidine, vinyl oxazole, vinyl isoxazole, vinyl thiazole, vinyl isothiazole, vinyl pyridazine, (meth)acryloyl pyrrolidone, (meth)acryloyl pyrrolidine, (meth)acryloyl piperidine, and N-methylvinylpyrrolidone; imide group-containing monomers, for example, maleimide monomers, such as N-cyclohexyl maleimide, N-isopropyl maleimide, N-lauryl, maleimide, and N-phenyl maleimide, itaconimide monomers, such as N-methylitaconimide, N-ethylitaconimide, N-butylitaconimide, N-octylitaconimide, N-2-ethylhexylitaconimide, N-laurylitaconimide, and N-cyclohexylitaconimide, and

succinimide monomers, such as N-(meth)acryloyloxymethylenesuccinimide, N-(meth)acryloyl-6-oxyhexamethylenesuccinimide, and N-(meth)acryloyl-8-oxyoctamethylenesuccinimide; and isocyanate group-containing monomers, such as 2-(meth)acryloyloxyethyl isocyanate.

### [1-7. Other Copolymerizable Monomers]

In addition to the above-described nitrogen atom-containing monomer and hydroxyl group-containing monomer, further examples of the copolymerizable monomer in the acrylic polymer (A) include alkoxyalkyl ester(meth)acrylates [e.g., 2-methoxyethyl(meth)acrylate, 2-ethoxyethyl(meth)acrylate, methoxy triethylene glycol(meth)acrylate, 3-methoxypropyl(meth)acrylate, 3-ethoxypropyl(meth)acrylate, 4-methoxybutyl(meth)acrylate, 4-ethoxybutyl(meth)acrylate]; epoxy group-containing monomers [e.g., glycidyl(meth)acrylate, methylglycidyl(meth)acrylate]; sulfonate group-containing monomers [e.g., sodium vinyl sulfonate]; phosphate group-containing monomers; (meth)acrylates having an alicyclic hydrocarbon group [e.g., cyclopentyl(meth)acrylate, cyclohexyl(meth)acrylate, isobornyl(meth)acrylate]; (meth)acrylates having an aromatic hydrocarbon group [e.g., phenyl(meth)acrylate, phenoxyethyl(meth)acrylate, benzyl(meth)acrylate]; vinyl esters [e.g., vinyl acetate, vinyl propionate); aromatic vinyl compounds [e.g., styrene, vinyl toluene]; olefins or dienes [e.g., ethylene, propylene, butadiene, isoprene, isobutylene]; vinyl ethers (e.g., vinyl alkyl ether]; and vinyl chlorides.

Further examples of the copolymerizable monomer in the acrylic polymer (A) include a polyfunctional monomer. The polyfunctional monomer is used as a crosslinking component. Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, and urethane acrylate. The polyfunctional monomers can be used singly or in combinations of two or more.

Although the content (ratio) of the polyfunctional monomer in all the monomer units of the acrylic polymer (A) is not especially limited, based on the total amount (100 parts by weight) of the monomer component forming the acrylic polymer (A), the content is preferably not more than 0.5 parts by weight (e.g., 0 to 0.5 parts by weight), more preferably 0 to 0.35 parts by weight, and even more preferably 0 to 0.2 parts by weight. It is preferred that the content of the polyfunctional monomer is not more than 0.5 parts by weight, because the pressure-sensitive adhesive layer tends to have suitable cohesion, and the adhesive strength and step absorbance tend to improve. If a crosslinking agent is used, it is not necessary to use a polyfunctional monomer. However, when not using a crosslinking agent, the content of the polyfunctional monomer is preferably 0.001 to 0.5 parts by weight, more preferably 0.001 to 0.35 parts by weight, and even more preferably 0.002 to 0.2 parts by weight.

### [1-8. Acrylic Polymer (B)]

If the above-described optical pressure-sensitive adhesive layer according to the present invention contains the acrylic polymer (A) as a base polymer, it is preferred that the optical pressure-sensitive adhesive layer according to the present invention contains an acrylic polymer (B) having a weight average molecular weight of 1,000 to 30,000 in addition to the acrylic polymer (A). As a result of including the acrylic polymer (B), adhesion to an adherend at the interface with the pressure-sensitive adhesive sheet improves, so that strong adhesion and an excellent resistance to foaming and release tend to be obtained. In the present specification, the “acrylic polymer (B) having a weight average molecular weight of 1,000 to 30,000” is sometimes simply referred to as “acrylic polymer (B)”.

Preferred examples of the acrylic polymer (B) include acrylic polymers formed from a (meth)acrylate having a ring structure in the molecule as an essential monomer component. More preferred examples include acrylic polymers formed from a (meth)acrylate having a ring structure in the molecule and an alkyl(meth)acrylate having a straight-chain or branched alkyl group as an essential monomer component. Specifically, preferred examples of the acrylic polymer (B) include acrylic polymers that include a (meth)acrylate having a ring structure in the molecule as a monomer unit, and more preferred examples include acrylic polymers that include a (meth)acrylate having a ring structure in the molecule and an alkyl(meth)acrylate having a straight-chain or branched alkyl group as a monomer unit.

The ring structure (ring) of the (meth)acrylate having a ring structure in the molecule (in one molecule) (hereinafter sometimes referred to as “ring-containing (meth)acrylate”) is not especially limited, and may be either an aromatic ring or a non-aromatic ring. Examples of aromatic rings include an aromatic carbon ring [e.g., a monocyclic carbon ring such as a benzene ring, a fused carbon ring such as a naphthalene ring] and various aromatic heterocyclic rings. Examples of non-aromatic rings include a non-aromatic aliphatic ring (a non-aromatic alicyclic ring) [e.g., a cycloalkane ring such as a cyclopentane ring, a cyclohexane ring, a cycloheptane ring, and a cyclooctane ring; a cycloalkene ring such as a cyclohexene ring], non-aromatic crosslinked rings [e.g., an alicyclic hydrocarbon ring (a crosslinked hydrocarbon ring), for example, a bicyclic hydrocarbon ring in pinane, pinene, bornane, norbornane, norbornene etc.; a tricyclic or more aliphatic hydrocarbon ring in adamantane etc.], and a non-aromatic heterocyclic ring [e.g., an epoxy ring, an oxolane ring, an oxetane ring].

Examples of the above-described tricyclic or more aliphatic hydrocarbon ring (a tricyclic or more crosslinked hydrocarbon ring) include a dicyclopentanyl group represented by the following formula (3a), a dicycopentenyl group represented by the following formula (3b), an adamantyl group represented by the following formula (3c), a tricyclopentanyl group represented by the following formula (3d), and a tricyclopentenyl group represented by the following formula (3e).

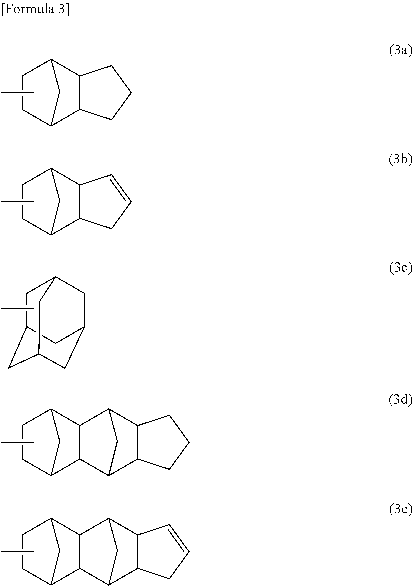

Specifically, examples of the ring-containing (meth)acrylate include a cycloalkyl(meth)acrylate, such as cyclopentyl(meth)acrylate, cyclohexyl(meth)acrylate, cycloheptyl(meth)acrylate, and cyclooctyl(meth)acrylate; a (meth)acrylate having a bicyclic aliphatic hydrocarbon ring, such as isobornyl(meth)acrylate; a (meth)acrylate having a tricyclic or more aliphatic hydrocarbon ring, such as dicyclopentanyl(meth)acrylate, dicyclopentanyloxyethyl(meth)acrylate, tricyclopentanyl(meth)acrylate, 1-adamantyl(meth)acrylate, 2-methyl-2-adamantyl(meth)acrylate, and 2-ethyl-2-adamantyl(meth)acrylate; and a (meth)acrylate having an aromatic ring, such as an aryl(meth)acrylate, such as phenyl(meth)acrylate, an aryloxyalkyl(meth)acrylate, such as phenoxyethyl(meth)acrylate, and an arylalkyl(meth)acrylate such as benzyl(meth)acrylate. Among these, especially, the ring-containing (meth)acrylate is preferably a non-aromatic ring-containing (meth)acrylate, more preferably cyclohexyl acrylate (CHA), cyclohexyl methacrylate (CHMA), dicyclopentanyl acrylate (DCPA), and dicyclopentanyl methacrylate (DCPMA), and even more preferably dicyclopentanyl acrylate (DCPA) and dicyclopentanyl methacrylate (DCPMA). The ring-containing (meth)acrylates can be used singly or in combinations of two or more.

Among the above-described non-aromatic ring-containing (meth)acrylates, it is preferred to use a (meth)acrylate having a tricyclic or more aliphatic hydrocarbon ring (especially, a tricyclic or more crosslinked hydrocarbon ring), because polymerization inhibition is less likely to occur. Further, if a (meth)acrylate having a dicyclopentanyl group represented by the above formula (3a), an adamantyl group represented by the above formula (3c), or a tricyclopentanyl group represented by the above formula (3d), which do not have an unsaturated bond, is used, the resistance to foaming and release can be increased, and adhesion to a low-polarity adherend, such as polyethylene and polypropylene, can be remarkably improved.

Although the content (ratio) of the above-described ring-containing (meth)acrylate in all the monomer units of the acrylic polymer (B) (the total amount of the monomer component forming the acrylic polymer (B)) is not especially limited, based on the total amount (100 parts by weight) of the monomer component forming the acrylic polymer (B), the content is preferably 10 to 90 parts by weight, and more preferably 20 to 80 parts by weight. It is preferred that the content of the above-described ring-containing (meth)acrylate is not less than 10 parts by weight, because the resistance to foaming and release tends to improve. Further, it is preferred that this content is not more than 90 parts by weight, because the pressure-sensitive adhesive layer tends to have suitable flexibility, and the adhesive strength and step absorbance tend to improve.

Further, examples of the above-described alkyl(meth)acrylate having a straight-chain or branched alkyl group as a monomer unit of the acrylic polymer (B) include alkyl(meth)acrylates whose alkyl group has 1 to 20 carbon atoms, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Among these, from the perspective of good compatibility with the acrylic polymer (A), methyl methacrylate (MMA) is preferred. The alkyl(meth)acrylates can be used singly or in combinations of two or more.

Although the content (ratio) of the above-described alkyl(meth)acrylate having a straight-chain or branched alkyl group in all the monomer units of the acrylic polymer (B) (the total amount of the monomer component forming the acrylic polymer (B)) is not especially limited, from the perspective of resistance to foaming and release, the content is preferably 10 to 90 parts by weight, more preferably 20 to 80 parts by weight, and even more preferably 20 to 60 parts by weight, based on the total amount (100 parts by weight) of the monomer component forming the acrylic polymer (B). It is preferred that the content is not less than 10 parts by weight, because the adhesive strength to adherends made from acrylic resin or polycarbonate, especially, tends to improve.

In addition to the above-described ring-containing (meth)acrylate and alkyl(meth)acrylate having a straight-chain or branched alkyl group as a monomer unit, the acrylic polymer (B) may also include a monomer that can be copolymerized (a copolymerizable monomer) with these monomers. Although the content (ratio) of the copolymerizable monomer in all the monomer units of the acrylic polymer (B) (the total amount of the monomer component forming the acrylic polymer (B)) is not especially limited, the content is preferably not more than 49.9 parts by weight (e.g., 0 to 49.9 parts by weight), and more preferably not more than 30 parts by weight, based on the total amount (100 parts by weight) of the monomer component forming the acrylic polymer (B). Further, the copolymerizable monomers can be used singly or in combinations of two or more.

Examples of the above-described copolymerizable monomer as a monomer unit of the acrylic polymer (B) (the above-described copolymerizable monomer forming the acrylic polymer (B)) include alkoxyalkyl ester(meth)acrylates [e.g., 2-methoxyethyl(meth)acrylate, 2-ethoxyethyl(meth)acrylate, methoxy triethylene glycol(meth)acrylate, 3-methoxypropyl(meth)acrylate, 3-ethoxypropyl(meth)acrylate, 4-methoxybutyl(meth)acrylate, 4-ethoxybutyl(meth)acrylate]; hydroxyl group-containing monomers [e.g., hydroxyalkyl(meth)acrylates, such as 2-hydroxyethyl(meth)acrylate, 2-hydroxypropyl(meth)acrylate, 2-hydroxybutyl(meth)acrylate, 3-hydroxypropyl(meth)acrylate, 4-hydroxybutyl(meth)acrylate, and 6-hydroxyhexyl(meth)acrylate, vinyl alcohol, allyl alcohol]; amide group-containing monomers [e.g., (meth)acrylamide, N,N-dimethyl(meth)acrylamide, N-methylol(meth)acrylamide, N-methoxymethyl(meth)acrylamide, N-butoxymethyl(meth)acrylamide, N-hydroxyethyl(meth)acrylamide]; amino group-containing monomers [e.g., aminoethyl(meth)acrylate, dimethylaminoethyl(meth)acrylate, t-butylaminoethyl(meth)acrylate]; cyano group-containing monomers [e.g., acrylonitrile, methacrylonitrile]; sulfonate group-containing monomers [e.g., sodium vinyl sulfonate]; phosphate group-containing monomers [e.g., 2-hydroxyethyl acryloyl phosphate]; isocyanate group-containing monomers [e.g., 2-methacryloyloxyethyl isocyanate], imide group-containing monomers [cyclohexylmaleimide, isopropyl maleimide].

Thus, it is preferred that the acrylic polymer (B) is an acrylic polymer that includes a (meth)acrylate having a ring structure in the molecule and an alkyl(meth)acrylate having a straight-chain or branched alkyl group as the monomer unit. Among these, it is preferred that the acrylic polymer (B) is an acrylic polymer that includes a ring-containing (meth)acrylate and the above-described alkyl(meth)acrylate having a straight-chain or branched alkyl group as the monomer unit. In this acrylic polymer that includes a ring-containing (meth)acrylate and an alkyl(meth)acrylate having a straight-chain or branched alkyl group as the monomer unit, although the amount of the ring-containing (meth)acrylate based on the total amount (100 parts by weight) of the monomer component forming the acrylic polymer (B) is not especially limited, the amount is preferably 10 to 90 parts by weight, and more preferably 20 to 80 parts by weight. Further, although the content of the alkyl(meth)acrylate having a straight-chain or branched alkyl group is not especially limited, the content is preferably 10 to 90 parts by weight, more preferably 20 to 80 parts by weight, and even more preferably 20 to 60 parts by weight.

Further, especially preferred specific structure of the acrylic polymer (B) includes as the monomer unit (1) at least one monomer selected from the group consisting of dicyclopentanyl acrylate, dicyclopentanyl methacrylate, cyclohexyl acrylate, and cyclohexyl methacrylate, and (2) acrylic polymer including methyl methacrylate. In the acrylic polymer (B) having such an especially preferred specific structure, the content of the (1) dicyclopentanyl acrylate, dicyclopentanyl methacrylate, cyclohexyl acrylate, and cyclohexyl methacrylate (if including two or more of these, the content thereof) in all the monomer units of the acrylic polymer (B) is, based on the total amount (100 parts by weight) of the monomer component forming the acrylic polymer (B), preferably 30 to 70 parts by weight, and the content of the (2) methyl methacrylate is preferably 30 to 70 parts by weight. However, the acrylic polymer (B) is not limited to the above-described specific structure.

The acrylic polymer (B) can be obtained by polymerizing the above-described monomer component by a known or customary polymerization method. Examples of the method for polymerizing the above-described acrylic polymer (B) include solution polymerization, emulsion polymerization, and bulk polymerization, polymerization by irradiating with an active energy ray (active energy ray polymerization). Among these, bulk polymerization and solution polymerization are preferred, and more preferred is solution polymerization.

Various kinds of common solvents may be used during the polymerization of the acrylic polymer (B). Examples of such solvents include organic solvents, for instance esters, such as ethyl acetate and n-butyl acetate; aromatic hydrocarbons, such as toluene and benzene; aliphatic hydrocarbons, such as n-hexane and n-heptane; alicyclic hydrocarbons, such as cyclohexane and methylcyclohexane; and ketones, such as methyl ethyl ketone and methyl isobutyl ketone. The solvents can be used singly or in combinations of two or more.

Further, during polymerization of the acrylic polymer (B), a known or customary polymerization initiator (e.g., a thermal polymerization initiator, a photopolymerization initiator) may be used. The polymerization initiators can be used singly or in combinations of two or more.

Examples of the thermal polymerization initiator include an azo-based initiator such as 2,2′-azobisisobutyronitrile (AIBN), 2,2′-azobis-2-methylbutyronitrile (AMBN), dimethyl 2,2′-azobis(2-methylpropionate), 4,4′-azobis-4-cyanovaleric acid, 2,2′-azobis(4-methoxy-2,4-dimethylvaleronitrile), 2,2′-azobis(2,4-dimethylvaleronitrile), 1,1′-azobis(cyclohexane-1-carbonitrile), and 2,2′-azobis(2,4,4-trimethylpentane); and a peroxide initiator, such as benzoylperoxide, t-butylhydroperoxide, di-t-butylperoxide, t-butylperoxybenzoate, dicumylperoxide, 1,1-bis(t-butylperoxy)-3,3,5-trimethylcyclohexane, and 1,1-bis(t-butylperoxy)cyclododecane. If solution polymerization is carried out, it is preferred that an oil-soluble polymerization initiator is used. The thermal polymerization initiators can be used singly or in combinations of two or more.

Although the amount of the thermal polymerization initiator used is not especially limited, for example, the amount used may be 0.1 to 15 parts by weight based on 100 parts by weight of all the monomer units (total amount of the monomer component forming the acrylic polymer (B)) of the acrylic polymer (B).

Further, the above-described photopolymerization initiator is not especially limited, and examples thereof may include the same photopolymerization initiators used for the polymerization of the acrylic polymer (A) that were described above. The amount of the photopolymerization initiator used is not especially limited, and may be appropriately selected.

In the polymerization of the acrylic polymer (B), to adjust the molecular weight (specifically, to adjust the weight average molecular weight to 1,000 to 30,000), a chain transfer agent may be used. Examples of the chain transfer agent include 2-mercaptoethanol, α-thioglycerol, 2,3-dimercapto-1-propanol, octyl mercaptane, t-nonyl mercaptane, dodecyl mercaptane (lauryl mercaptane), t-dodecyl mercaptane, glycidyl mercaptane, thioglycolic acid, methyl thioglycolate, ethyl thioglycolate, propyl thioglycolate, butyl thioglycolate, t-butyl thioglycolate, 2-ethylhexyl thioglycolate, octyl thioglycolate, isooctyl thioglycolate, decyl thioglycolate, dodecyl thioglycolate, a thioglycolic ester of ethyleneglycol, thioglycolic ester of neopentylglycol, thioglycolic ester of pentaerythritol, and an α-methylstyrene dimer. Among these, from the perspective of suppressing whitening of the pressure-sensitive adhesive sheet due to humidification, α-thioglycerol and methyl thioglycolate are preferable, and α-thioglycerol is especially preferable. The chain transfer agents can be used singly or in combinations of two or more.

Although the content (amount used) of the chain transfer agent is not especially limited, the content is preferably 0.1 to 20 parts by weight, more preferably 0.2 to 15 parts by weight, and even more preferably 0.3 to 10 parts by weight, based on 100 parts by weight of all the monomer units of the acrylic polymer (B) (the total amount of the monomer component forming the acrylic polymer (B)). By setting the content (amount used) of the chain transfer agent in the above range, an acrylic polymer having a weight average molecular weight that is controlled to 1,000 to 30,000 can be easily obtained.

The weight average molecular weight (Mw) of the acrylic polymer (B) is 1,000 to 30,000, preferably 1,000 to 20,000, more preferably 1,500 to 10,000, and even more preferably 2,000 to 8,000. Since the weight average molecular weight of the acrylic polymer (B) is not less than 1,000, the adhesive strength and a retention property are improved, and the resistance to foaming and release is improved. On the other hand, since the weight average molecular weight of the acrylic polymer (B) is not more than 30,000, the adhesive strength tends to increase and the resistance to foaming and release is improved.

The weight average molecular weight (Mw) of the acrylic polymer (B) can be determined by a GPC method in terms of standard polystyrene. For example, the weight average molecular weight can be measured using the high-speed GPC apparatus “HPLC-8120 GPC” (manufactured by Tosoh Corporation) under the following conditions.

Column: TSK gel, Super HZM-H/HZ4000/HZ3000/HZ2000

### Solvent: Tetrahydrofuran

Flow rate: 0.6 ml/min

Although the glass transition temperature (Tg) of the acrylic polymer (B) is not especially limited, it is preferably 20 to 300° C., more preferably 30 to 300° C., and even more preferably 40 to 300° C. It is preferred that the glass transition temperature of the acrylic polymer (B) is not less than 20° C., because the resistance to foaming and release tends to be improved. Further, it is preferred that the glass transition temperature of the acrylic polymer (B) is not more than 300° C., because the pressure-sensitive adhesive layer has suitable flexibility, a good adhesive strength and a good step absorbability tend to be obtained, and excellent adhesion reliability tends to be obtained.

The glass transition temperature (Tg) of the acrylic polymer (B) is a glass transition temperature (theoretical value) represented by the following equation.

1/Tg=W₁/Tg₁+W₂/Tg₂+ . . . +Wₙ/Tgₙ

In the above equation, Tg represents the glass transition temperature (unit: K) of the acrylic polymer (B), Tgᵢ represents the glass transition temperature (unit: K) when a monomer i forms a homopolymer, and Wᵢ represents a weight fraction of the total amount of the monomer component of the monomer i (i=1, 2, . . . n).

As the Tg of the homopolymer of the monomers forming the acrylic polymer (B), the values listed in the following Table 1 can be used. Further, as the Tg of the homopolymer of monomers not listed in Table 1, the values described in “Polymer Handbook” (3rd Edition, John Wiley & Sons, Inc., 1.989) can be used. In addition, as the Tg of the homopolymer of monomers that are not described even in that publication, a value obtained by the above-described measurement method (peaktop temperatures of tan δ obtained by a viscoelasticity test) can be employed.

TABLE 1

| | Composition | Tg [° C.] |
|---|---|---|
| Homopolymer | Methyl Methacrylate (MMA) | 105 |
| | Dicyclopentanyl Methacrylate (DCPMA) | 175 |
| | Dicyclopentanyl Acrylate (DCPA) | 120 |
| | Isobornyl Methacrylate (IBXMA) | 173 |
| | Isobornyl Acrylate (IBXA) | 97 |
| | Cyclohexyl Methacrylate (CHMA) | 66 |
| | 1-Adamantyl Methacrylate (ADMA) | 250 |
| | 1-Adamantyl Acrylate (ADA) | 153 |
| Copolymer | DCPMA/MMA = 60/40 | 144 |

The copolymer “DCPMA/MMA = 60/40” in Table 1 means a copolymer having 60 parts by weight of DCPMA and 40 parts by weight of MMA.

When the above-described optical pressure-sensitive adhesive layer according to the present invention contains the acrylic polymers (A) and (B), although the content of the acrylic polymer (B) is not especially limited, it is preferably 1 to 30 parts by weight, more preferably 2 to 20 parts by weight, and even more preferably 2 to 10 parts by weight based on 100 parts by weight of the acrylic polymer (A). Namely, although the content of the acrylic polymer (B) in the optical pressure-sensitive adhesive layer according to the present invention is not especially limited, it is preferred that the content is 1 to 30 parts by weight, more preferably 2 to 20 parts by weight, and even more preferably 2 to 10 parts by weight, based on 100 parts by weight of all the monomer units of the acrylic polymer (A). Although the content of the acrylic polymer (B) in the pressure-sensitive adhesive composition is not especially limited, it is preferred that the content is, for example, 1 to 30 parts by weight, more preferably 2 to 20 parts by weight, and even more preferably 2 to 10 parts by weight based on 100 parts by weight of the above-described monomer mixture. It is preferred that the content of the acrylic polymer (B) is not less than 1 part by weight, because excellent adhesion and an excellent resistance to foaming and release tend to be obtained. Further, it is preferred that the content of the acrylic polymer (B) is not more than 30 parts by weight, because excellent transparency and adhesion reliability tend to be obtained.

The method for producing the pressure-sensitive adhesive layer containing the acrylic polymers (A) and (B) is not especially limited. For example, this pressure-sensitive adhesive layer is produced by optionally admixing the benzotriazole-based compound, the acrylic polymer (B), additives and the like to a monomer mixture, or partially polymerized product thereof, forming the acrylic polymer (A).

### [1-9. Additives]

To the extent that the characteristics of the present invention are not harmed, the optical pressure-sensitive adhesive layer according to the present invention may optionally include known additives, such as a crosslinking agent, a crosslinking accelerator, a silane coupling agent, a tackifying resin (rosin derivative, polyterpene resin, petroleum resin, oil-soluble phenol etc.), an antiaging agent, a filler, a colorant (dye or pigment), a UV absorbing agent, an antioxidant, a chain transfer agent, a plasticizer, a softener, a surfactant, and an antistatic agent. Such additives can be used singly or in combinations of two or more.

By including a crosslinking agent in the pressure-sensitive adhesive layer, the gel fraction tends to increase due to the base polymer crosslinking, so that the resistance to foaming and release tends to be improved. For example, since greater control of the gel fraction can be easily obtained by crosslinking the acrylic polymer (especially, the acrylic polymer (A)), it is easier to improve the resistance to foaming and release. Examples of the crosslinking agent include isocyanate crosslinking agents, epoxy crosslinking agents, melamine crosslinking agents, peroxide crosslinking agents, urea crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents, and amine crosslinking agents. Among these, if the optical pressure-sensitive adhesive layer according to the present invention contains the acrylic polymer (A) as the base polymer, from the perspective of improving the resistance to foaming and release, an isocyanate crosslinking agent or an epoxy crosslinking agent is preferred, and an isocyanate crosslinking agent is more preferred. The crosslinking agents can be used singly or in combinations of two or more.

Examples of isocyanate crosslinking agents (a polyfunctional isocyanate compound) include lower aliphatic polyisocyanates, such as 1,2-ethylene diisocyanate, 1,4-butylenediisocyanate, and 1,6-hexamethylene diisocyanate; alicyclic polyisocyanates, such as cyclopentylene diisocyanate, cyclohexylene diisocyanate, isophorone diisocyanate, hydrogenated tolylene diisocyanate, and hydrogenated xylene diisocyanate; and aromatic polyisocyanates, such as 2,4-tolylene diisocyanate, 2,6-tolylene diisocyanate, 4,4′-diphenylmethane diisocyanate, and xylylene diisocyanate. Further, the isocyanate crosslinking agent may be, for example, a commercially available product, such as a trimethylolpropane/tolylene diisocyanate adduct [trade name “Coronate L”, manufactured by Nippon Polyurethane Industry Co., Ltd.], a trimethylolpropane/hexamethylene diisocyanate adduct [trade name “Coronate HL”, manufactured by Nippon Polyurethane Industry Co., Ltd.], or a trimethylolpropane/xylylene diisocyanate adduct [trade name “Takenate 110N”, manufactured by Mitsui Chemicals Co., Ltd.].

Examples of epoxy crosslinking agents (a polyfunctional epoxy compound) include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl) isocyanurate, resorcin diglycidyl ether, bisphenol-S-diglycidyl ether, and an epoxy resin having two or more epoxy groups in the molecule. The epoxy crosslinking agent may be, for example, a commercially available product, such as “Tetrad C” (trade name) manufactured by Mitsubishi Gas Chemical Company, Inc.

Although the content of the crosslinking agent in the optical pressure-sensitive adhesive layer is not especially limited, for example, if the optical pressure-sensitive adhesive layer according to the present invention contains the acrylic polymer (A) as the base polymer, the content is preferably 0.001 to 10 parts by weight, and more preferably 0.01 to 5 parts by weight, based on 100 parts by weight of the acrylic polymer (A). It is preferred that the content of the crosslinking agent is not less than 0.001 parts by weight, because the resistance to foaming and release tends to be improved. On the other hand, it is preferred that the content of the crosslinking agent is not more than 10 parts by weight, because the pressure-sensitive adhesive layer has suitable flexibility, and the adhesive strength tends to be improved.

It is preferred that the optical pressure-sensitive adhesive layer includes a silane coupling agent, because excellent adhesion to glass (especially, excellent adhesion reliability to glass at a high temperature and high humidity). Examples of the silane coupling agent include, but are not especially limited to, γ-glycidoxypropyltrimethoxysilane, γ-glycidoxypropyltriethoxysilane, γ-aminopropyltrimethoxysilane, and N-phenyl-aminopropyltrimethoxysilane. Among these, γ-glycidoxypropyltrimethoxysilane is preferable. Further, as the silane coupling agent, for example, a commercially available product, such as “KBM-403” (trade name, manufactured by Shin-Etsu Chemical Co., Ltd.) may be used. The silane coupling agents can be used singly or in combinations of two or more.

Although the content of the silane coupling agent in the optical pressure-sensitive adhesive layer is not especially limited, for example, if the optical pressure-sensitive adhesive layer according to the present invention contains the acrylic polymer (A) as the base polymer, from the perspective of improving the adhesion reliability to glass, the content is preferably 0.01 to 1 part by weight, and more preferably 0.03 to 0.5 parts by weight, based on 100 parts by weight of the acrylic polymer (A).

### [2. Pressure-Sensitive Adhesive Sheet]

The pressure-sensitive adhesive sheet according to the present invention is not especially limited as long as it has the above-described optical pressure-sensitive adhesive layer (optical pressure-sensitive adhesive layer according to the present invention).

The pressure-sensitive adhesive sheet according to the present invention may be a double-sided pressure-sensitive adhesive sheet in which both faces are a pressure-sensitive adhesive layer surface, or may be a single-sided pressure-sensitive adhesive sheet in which only one face is a pressure-sensitive adhesive layer surface. Among these, from the perspective of laminating two members together, a double-sided pressure-sensitive adhesive sheet is preferred. In the present specification, the definition of “pressure-sensitive adhesive sheet” includes a tape-like object, namely, “pressure-sensitive adhesive tape”. Further, in the present specification, the pressure-sensitive adhesive layer surface is sometimes referred to as “pressure-sensitive adhesive face”.

The pressure-sensitive adhesive sheet according to the present invention may be provided with a separator (release liner) on a pressure-sensitive adhesive face until usage.

The pressure-sensitive adhesive sheet according to the present invention may be a so-called “substrateless type” pressure-sensitive adhesive sheet (hereinafter sometimes referred to as “substrateless pressure-sensitive adhesive sheet”) that does not have a substrate (substrate layer), or may be a pressure-sensitive adhesive sheet that has a substrate (hereinafter sometimes referred to as “pressure-sensitive adhesive sheet with a substrate”). Examples of the substrateless pressure-sensitive adhesive sheet include a double-sided pressure-sensitive adhesive sheet formed from just the above-described pressure-sensitive adhesive layer, and a double-sided pressure-sensitive adhesive sheet formed from the above-described pressure-sensitive adhesive layer and a pressure-sensitive adhesive layer other than the above-described pressure-sensitive adhesive layer (sometimes referred to as “other pressure-sensitive adhesive layer”). On the other hand, examples of the pressure-sensitive adhesive sheet with a substrate include a pressure-sensitive adhesive sheet having the above-described pressure-sensitive adhesive layer on at least one side of the substrate. Of these, a substrateless pressure-sensitive adhesive sheet (substrateless double-sided pressure-sensitive adhesive sheet) is preferred, and a substrateless double-sided pressure-sensitive adhesive sheet formed from just the above-described pressure-sensitive adhesive layer is more preferred. Here, the definition of “substrate (substrate layer)” does not include the separator that is peeled off when the pressure-sensitive adhesive sheet is used (laminated).

It is preferred that the pressure-sensitive adhesive sheet according to the present invention is a substrateless pressure-sensitive adhesive sheet. This is because it is much more meaningful to be able to provide a substrateless pressure-sensitive adhesive sheet with a corrosion inhibition function, since a pressure-sensitive adhesive sheet with a substrate that uses a moisture-proof substrate can already be said to have a certain level of a corrosion inhibition function.

### [2-1. Various Properties of the Pressure-Sensitive Adhesive Sheet]

Although the 180° peel adhesive strength of the pressure-sensitive adhesive sheet according to the present invention to a glass plate (especially, the 180° peel adhesive strength of the pressure-sensitive adhesive face provided by the above-described pressure-sensitive adhesive layer (optical pressure-sensitive adhesive layer according to the present invention) is not especially limited, since sufficient adhesion to a metal surface can be obtained and a corrosion inhibition effect also improves if the adhesive strength is high, the 180° peel adhesive strength is preferably not less than 8 N/20 mm, more preferably not less than 10 N/20 mm, even more preferably not less than 12 N/20 mm, and still even more preferably not less than 14 N/20 mm. If the 1.80° peel adhesive strength of the pressure-sensitive adhesive sheet according to the present invention to a glass plate is not less than a predetermined value, the adhesion to glass and suppressibility of floating at a step are greatly improved. Further, although an upper limit of the 180° peel adhesive strength of the pressure-sensitive adhesive sheet according to the present invention to a glass plate is not especially limited, for example, it is preferably 40 N/20 mm, and more preferably 60 N/20 mm. The 180° peel adhesive strength to a glass plate can be determined by the below-described 180° peel adhesive strength measurement method.

Examples of the glass plate include, but are not especially limited to, “Soda Lime Glass #0050”, (trade name, manufactured by Matsunami Glass Ind. Ltd.). Further examples include alkali-free glass and chemically-strengthened glass.

Although the 180° peel adhesive strength of the pressure-sensitive adhesive sheet according to the present invention to an acrylic plate (especially, the 180° peel adhesive strength of the pressure-sensitive adhesive face provided by the above-described pressure-sensitive adhesive layer (optical pressure-sensitive adhesive layer according to the present invention) is not especially limited, since sufficient adhesion to a metal surface can be obtained and a corrosion inhibition effect also improves if the adhesive strength is high, the 180° peel adhesive strength is preferably not less than 10 N/20 mm, more preferably not less than 12 N/20 mm, and even more preferably not less than 14 N/20 mm. It is preferred that the pressure-sensitive adhesive sheet according to the present invention has an 180° peel adhesive strength to an acrylic plate of not less than 10 N/20 mm, because good adhesion to an acrylic plate and good suppressibility of floating at a step tend to be obtained. Further, although an upper limit of the 180° peel adhesive strength of the pressure-sensitive adhesive sheet according to the present invention to an acrylic plate is not especially limited, for example, it is 40 N/20 mm, and more preferably 60 N/20 mm. The 180° peel adhesive strength to an acrylic plate can be determined by the below-described 180° peel adhesive strength measurement method.

Examples of the acrylic plate include, but are not especially limited to, a PMMA plate (trade name: “Acrylite”, manufactured by Mitsubishi Rayon Co., Ltd.,).

### (A-1. 180° Peel Adhesive Strength Measurement Method)

The pressure-sensitive adhesive face of a pressure-sensitive adhesive sheet is laminated to an adherend, then pressure-bonded by moving a 2-kg roller back and forth once and aged under a 23° C., 50% RH atmosphere for 30 minutes. After the aging, the pressure-sensitive adhesive sheet is peeled off from the adherend under a 23° C., 50% RH atmosphere at a tensile speed of 300 mm/min and a peel angle of 180° based on JIS Z0237, and the 180° peel adhesive strength (N/20 mm) is measured.

### (B. Thickness)

Although the thickness (total thickness) of the pressure-sensitive adhesive sheet according to the present invention is not especially limited, it is preferably 12 to 350 μm, and more preferably 12 to 300 μm. It is preferred to set the thickness to not less than a predetermined value, because peeling is less likely to occur at a step site. Further, it is preferred to set the thickness to be not more than a predetermined value, because an excellent appearance tends to be maintained during production. Here, the thickness of the separator is not included in the thickness of the pressure-sensitive adhesive sheet according to the present invention.

### (C. Haze)

Although the haze (based on JIS K7136) of the pressure-sensitive adhesive sheet according to the present invention is not especially limited, it is preferably not more than 1.0% and more preferably not more than 0.8%. It is preferred that the haze is not more than 1.0%, because excellent transparency and excellent appearance can be obtained. The haze can be measured using a haze meter (manufactured by Murakami Color Research Laboratory Co., Ltd., trade name “HM-150”) by, for example, employing a specimen obtained by leaving a pressure-sensitive adhesive sheet for at least 24 hours in an ordinary state (23° C., 50% RH), then peeling off a separator if there is one, and laminating the pressure-sensitive adhesive sheet on a slide glass (e.g., having a total light transmittance of 91.8% and a haze of 0.4%).

### (D. Total Light Transmittance)

Although the total light transmittance (based on JIS K7361-1) of the pressure-sensitive adhesive sheet according to the present invention in the visible light wavelength region is not especially limited, it is preferably not less than 85%, and more preferably not less than 88%. It is preferred that the total light transmittance is not less than 85%, because excellent transparency and excellent appearance are obtained. Further, this total light transmittance can be measured using a haze meter (manufactured by Murakami Color Research Laboratory Co., Ltd., trade name “HM-150”) by, for example, employing a specimen obtained by leaving a pressure-sensitive adhesive sheet for at least 24 hours in an ordinary state (23° C., 50% RH), then peeling off a separator if there is one, and laminating the pressure-sensitive adhesive sheet on a slide glass (e.g., having a total light transmittance of 91.8% and a haze of 0.4%).

### [2-2. Pressure-Sensitive Adhesive Sheet Production Method]

Although the method for producing the pressure-sensitive adhesive sheet according to the present invention is not especially limited, a known or customary method is preferred. For example, if the pressure-sensitive adhesive sheet according to the present invention is a substrateless pressure-sensitive adhesive sheet, the pressure-sensitive adhesive sheet can be obtained by forming the pressure-sensitive adhesive layer (optical pressure-sensitive adhesive layer according to the present invention) on the separator by the above-described method. Further, if the pressure-sensitive adhesive sheet according to the present invention is a pressure-sensitive adhesive sheet with a substrate, the pressure-sensitive adhesive sheet may be obtained by directly forming the pressure-sensitive adhesive layer on the surface of the substrate (direct method), or may be obtained by first forming the pressure-sensitive adhesive layer on the separator, and then transferring (laminating) onto the substrate to provide the pressure-sensitive adhesive layer on the substrate (transfer method).

### [2-3. Pressure-Sensitive Adhesive Layer in the Pressure-Sensitive Adhesive Sheet]

Although the gel fraction (ratio of solvent insoluble matter) of the above-described pressure-sensitive adhesive layer (optical pressure-sensitive adhesive layer according to the present invention) in the pressure-sensitive adhesive sheet according to the present invention is not especially limited, it is preferably 65 to 99%, more preferably 68 to 95%, and even more preferably 70 to 95%. It is preferred that the gel fraction is not less than 65%, because the cohesion of the pressure-sensitive adhesive layer tends to improve, foaming and release at the interface with an adherend under a high-temperature environment tend to be suppressed, and an excellent resistance to foaming and release tends to be obtained. Further, it is preferred that the gel fraction is not more than 99%, because suitable flexibility can be obtained and adhesion is further improved.

### (Gel Fraction)

Specifically, the gel fraction (ratio of the solvent insoluble component) is, for example, a value calculated based on the following “method for measuring gel fraction”.

About 0.1 g of the pressure-sensitive adhesive layer is sampled from a pressure-sensitive adhesive sheet, wrapped with a porous tetrafluoroethylene sheet (trade name: “NTF1122”, manufactured by Nitto Denko Corporation) having an average pore size of 0.2 μm, and tied up with a kite string. The weight at this point is measured, and that weight is taken as the weight before dipping. The weight before dipping is the total weight of the pressure-sensitive adhesive layer (the pressure-sensitive adhesive layer sampled above), the tetrafluoroethylene sheet, and the kite string. The total weight of the tetrafluoroethylene sheet and the kite string is also measured, and this weight is taken as the wrapper weight.

Next, the pressure-sensitive adhesive layer wrapped with the tetrafluoroethylene sheet and tied up with kite string (referred to as the “sample”) is placed in a 50 ml vessel, filled with ethyl acetate, and then left at 23° C. for 7 days. The sample (after ethyl acetate treatment) is then taken out of the vessel, transferred to an aluminum cup, and dried in a dryer at 130° C. for 2 hours to remove the ethyl acetate. The weight is then measured, and this weight is taken as the weight after dipping.

The gel fraction is then calculated according to the following formula.

Gel fraction[% (wt. %)]=(X−Y)/(Z−Y)×100

The gel fraction can be controlled based on, for example, the monomer composition and weight average molecular weight of the base polymer (e.g., the acrylic polymer (A)), and the amount of crosslinking agent used (added).

### (300% Tensile Residual Stress)

Although the 300% tensile residual stress of the above-described pressure-sensitive adhesive layer (optical pressure-sensitive adhesive layer according to the present invention) is not especially limited, it is preferably 7 to 25 N/cm², more preferably 7 to 20 N/cm², even preferably 7 to 16 N/cm², and even more preferably 7 to 14 N/cm². It is preferred that the 300% tensile residual stress is not less than 7 N/cm², because a good resistance to foaming and release tends to be obtained. Further, it is preferred that the 300% tensile residual stress is not more than 25 N/cm², because a good stress relaxation property and good step conformability tend to be obtained.

If the pressure-sensitive adhesive sheet according to the present invention has the above-described pressure-sensitive adhesive layer in which the 300% tensile residual stress is within the specific range, an excellent stress relaxation property tends to be obtained, and excellent step conformability tends to be exhibited. For example, good conformability can be exhibited even against large steps (e.g., a step having a height of about 45 μm, especially a step having a height of 20 to 50 μm).

The 300% tensile residual stress is a value (N/cm²) obtained by drawing a pressure-sensitive adhesive layer in a length direction to be stretched (strained) by 300% under a 23° C. environment, maintaining that stretch, determining the tensile load applied on the pressure-sensitive adhesive layer after 300 seconds has elapsed from the end of drawing, and dividing this tensile load by the initial cross-sectional area of the pressure-sensitive adhesive layer (the cross-sectional area before drawing). Here, the initial stretch of the pressure-sensitive adhesive layer is 100%.

### (Thickness)

Although the thickness of the above-described pressure-sensitive adhesive layer (especially, optical pressure-sensitive adhesive layer according to the present invention) is not especially limited, it is preferably 12 to 350 μm, and more preferably 12 to 300 μm. It is preferred to set the thickness to not less than a predetermined value, because step conformability and adhesion reliability improve. Further, it is preferred to set the thickness to be not more than a predetermined value, because handleability and production properties are especially excellent.

### (Production Method)

Although the production method of the above-described pressure-sensitive adhesive layer (optical pressure-sensitive adhesive layer according to the present invention) is not especially limited, the pressure-sensitive adhesive layer can be produced by, for example, coating (applying) the above-described pressure-sensitive adhesive composition on a substrate or a release liner, and optionally drying or curing, or drying and curing.

In the coating (applying) of the pressure-sensitive adhesive composition, a known coating method can be used. For example, a coater such as a gravure roll coater, a reverse roll coater, a kiss roll coater, a dip roll coater, a bar coater, a knife coater, a spray coater, a comma coater, and a direct coater can be used.

### [2-4. Other Layers of the Pressure-Sensitive Adhesive Sheet]

The pressure-sensitive adhesive sheet according to the present invention may have another layer in addition to the above-described pressure-sensitive adhesive layer (optical pressure-sensitive adhesive layer according to the present invention). Examples of another layer include another pressure-sensitive adhesive layer (a pressure-sensitive adhesive layer other than the above-described pressure-sensitive adhesive layer), an intermediate layer, and an undercoat layer. Further, the pressure-sensitive adhesive sheet according to the present invention may have two or more other layers.

### [2-5. Pressure-Sensitive Adhesive Sheet Substrate]

Examples of a substrate when the pressure-sensitive adhesive sheet according to the present invention is a pressure-sensitive adhesive sheet with the substrate include, but are not especially limited to, various optical films, such as a plastic film, an antireflection (AR) film, a polarizing plate, and a retardation plate. Examples of the material of the plastic film and the like include plastic materials, such as polyester resins such as polyethylene terephthalate (PET), acrylic resins such as polymethyl methacrylate (PMMA), polycarbonate, triacetyl cellulose (TAC), polysulfone, polyarylate, polyimide, polyvinyl chloride, polyvinyl acetate, polyethylene, polypropylene, an ethylene-propylene copolymer, and cyclic olefin-based polymers such as “Arton” (trade name, cyclic olefin-based polymer, manufactured by JSR) and “Zeonor” (trade name, cyclic olefin-based polymer, manufactured by Nippon Zeon Co., Ltd.). These plastic materials can be used singly or in combinations of two or more. Further, the “substrate” is a portion laminated to an adherend together with the pressure-sensitive adhesive layer, when the pressure-sensitive adhesive sheet is laminated to the adherend. The separator (release liner) released during use (during lamination) of the pressure-sensitive adhesive sheet is not included in “substrate”.

The substrate is preferably transparent. Although the total light transmittance (based on JIS K7361-1) in the visible light wavelength region of the substrate is not especially limited, it is preferably not less than 85%, and more preferably not less than 88%. Further, although the haze (based on JIS K7136) of the substrate is not especially limited, it is preferably not more than 1.0%, and more preferably not more than 0.8%. Examples of such a transparent substrate include a PET film or a non-oriented film such as “Arton” (trade name) and “Zeonor” (trade name).

Although the thickness of the substrate is not especially limited, it is preferably 12 to 500 μm, for example. The substrate may be in the form of a single layer or multilayer. Further, the surface of the substrate may be appropriately subjected to a known or customary surface treatment, such as a physical treatment such as a corona discharge treatment and a plasma treatment, and a chemical treatment such as an undercoat treatment, for example.

### [2-6. Pressure-Sensitive Adhesive Sheet Separator]

The pressure-sensitive adhesive sheet according to the present invention may be provided with a separator (release liner) on the pressure-sensitive adhesive face until usage. If the pressure-sensitive adhesive sheet according to the present invention is a double-sided pressure-sensitive adhesive sheet, each pressure-sensitive adhesive face may be protected using two separators, respectively, or protected in such a way that both faces are wound in a roll shape using one separator acting as a release face. The separator, which is used as a protective material of the pressure-sensitive adhesive layer, is peeled off when laminating to the adherend. If the pressure-sensitive adhesive sheet according to the present invention is a substrateless pressure-sensitive adhesive sheet, the separator also functions as a support for the pressure-sensitive adhesive layer. The separator does not have to be provided.

Any customary release paper or the like may be used as the separator. Examples of the separator include, but are not especially limited to, a substrate having a release-treated layer, a low adhesion substrate formed from a fluoropolymer, and a low adhesion substrate formed from a non-polar polymer. Examples of a substrate having such a release-treated layer include a plastic film or paper whose surface has been treated with a silicone, long-chain alkyl, fluorine, molybdenum sulfide or similar release agent. Examples of the fluoropolymer in the low adhesion substrate formed from a fluoropolymer include polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer. Examples of the non-polar polymer include an olefin resin (e.g., polyethylene, polypropylene), a polyester substrate (e.g., a polyethylene terephthalate substrate, a polyethylene naphthalate substrate, and a polybutylene terephthalate substrate). The separator can be formed by using a known or customary method. Further, the thickness and the like of the separator are not especially limited.

### [2-7. Pressure-Sensitive Adhesive Sheet Applications Etc.]

Since the pressure-sensitive adhesive sheet according to the present invention has the above-described pressure-sensitive adhesive layer (optical pressure-sensitive adhesive layer according to the present invention), it has excellent adhesion and an excellent resistance to foaming and release, as well as an excellent stress relaxation property and excellent step conformability. Consequently, the pressure-sensitive adhesive sheet according to the present invention has excellent adhesion reliability, especially adhesion reliability at a high temperature. Further, the occurrence of undulations under a high-temperature environment can be suppressed very well.

Consequently, the pressure-sensitive adhesive sheet according to the present invention may be effectively used on an adherend which is susceptible to foaming at an interface at high temperatures. For example, in some cases polymethyl methacrylate resin (PMMA) contains unreacted monomers, and is thus susceptible to foaming at high temperatures due to the extraneous materials. Further, polycarbonate (PC) tends to produce water and an outgas of carbon dioxide at high temperatures. Since the pressure-sensitive adhesive sheet according to the present invention has an excellent resistance to foaming and release, it may also be effectively used on a plastic adherend including such a resin.

Still further, in addition to an adherend having a small coefficient of linear expansion, the pressure-sensitive adhesive sheet according to the present invention is effectively used on an adherend having a large coefficient of linear expansion. Examples of such an adherend having a small coefficient of linear expansion include, but are not especially limited to, a glass plate (coefficient of linear expansion: from 0.3×10⁻⁵ to 0.8×10⁻⁵/° C.), and a polyethylene terephthalate substrate (PET film, coefficient of linear expansion: from 1.5×10⁻⁵ to 2×10⁻⁵/° C.). In addition, examples of such an adherend having a large coefficient of linear expansion include, but are not especially limited to, a resin substrate having a large coefficient of linear expansion. More specifically, such examples include a polycarbonate resin substrate (PC, coefficient of linear expansion: from 7×10⁻⁵ to 8×10⁻⁵/° C.), a polymethyl methacrylate resin substrate (PMMA, coefficient of linear expansion: from 7×10⁻⁵ to 8×10⁻⁵/° C.), a cycloolefin polymer substrate (COP, coefficient of linear expansion: from 6×10⁻⁵ to 7×10⁻⁵/° C.), “Zeonor” (trade name, manufactured by Nippon Zeon Co., Ltd.), and “Arton” (trade name, manufactured by JSR).

The pressure-sensitive adhesive sheet according to the present invention is effectively used for lamination between an adherend having a small coefficient of linear expansion and an adherend having a large coefficient of linear expansion. Specifically, the pressure-sensitive adhesive sheet according to the present invention may be preferably used for lamination between a glass adherend (e.g., a glass plate, chemically-strengthened glass, a glass lens) and the above-described resin substrate having a large coefficient of linear expansion.

Thus, the pressure-sensitive adhesive sheet according to the present invention is effectively used for lamination between adherends formed from various materials, and especially a glass adherend and a plastic adherend. The plastic adherend may also be an optical film such as a plastic film having an ITO (oxide of indium and tin) layer on a surface.

Furthermore, the pressure-sensitive adhesive sheet according to the present invention is effectively used on, in addition to an adherend having a smooth surface, an adherend having a step on the surface thereof. Especially, even when at least one of a glass adherend and the above-described resin substrates having a large coefficient of linear expansion has a step on the surface thereof, the pressure-sensitive adhesive sheet according to the present invention can be effectively used for lamination between the glass adherend and the above-described resin substrate having a large coefficient of linear expansion.

For example, the pressure-sensitive adhesive sheet according to the present invention, which is a laminate formed from a PET film (polyethylene terephthalate support), an ITO layer, and copper wiring, can be preferably used when fixing to an adherend a laminate having a structure in which an ITO layer has been patterned and metal wiring is connected to that ITO pattern. This is because although undulations can occur in this laminate under a high-temperature environment because the laminate is formed from materials having a different modulus of elasticity and linear expansion, the pressure-sensitive adhesive sheet according to the present invention can effectively suppress the occurrence of undulations under a high-temperature environment.

The pressure-sensitive adhesive sheet according to the present invention can be preferably used for the application of manufacturing portable electronic devices. This is because since the pressure-sensitive adhesive sheet according to the present invention can suppress the occurrence of undulations under a high-temperature environment, a portable electronic device having a display unit that looks good can be easily produced. Examples of such portable electronic devices include a mobile phone, PHS, a smartphone, a tablet (tablet computer), a mobile computer (mobile PC), a personal digital assistant (PDA), an electronic notebook, a portable broadcast receiver such as a portable television receiver and a portable radio receiver, a portable game machine, a portable audio player, a portable DVD player, a camera such as a digital camera, and a camcorder video camera.

The pressure-sensitive adhesive sheet according to the present invention can be preferably used for laminating members or modules configuring a portable electronic device to each other, fixing a member or module configuring a portable electronic device to a housing and the like. More specifically, examples thereof include lamination between a cover glass or lens (especially a glass lens) and a touch panel or touch sensor, fixation of a cover glass or lens (especially a glass lens) to a housing, fixation of a display panel to a housing, fixation of an input device such as a sheet keyboard and a touch panel to a housing, lamination between a protective panel of an information display part and a housing, lamination of housings to each other, lamination between a housing and a decorative sheet, and fixation or lamination of various members or modules configuring a portable electronic device. The term “display panel” in the present specification means a structure which is configured from at least a lens (especially a glass lens) and a touch panel. In addition, the lens in the present specification is a concept including both a transparent body that exhibits a light refracting action and a transparent body not having a light refracting action. Namely, the term lens in the present specification also includes a mere window panel not having a light refracting action.

Further, the pressure-sensitive adhesive sheet according to the present invention can be preferably used for an optical application. Namely, the pressure-sensitive adhesive sheet according to the present invention is preferably an optical pressure-sensitive adhesive sheet which is used for an optical application. More specifically, the pressure-sensitive adhesive sheet according to the present invention is preferably used for, for example, an application of laminating an optical component (for lamination of an optical component) and an application of manufacturing a product (optical product) using the above-described optical component.

### [3. Optical Component]

The optical component according to the present invention is not especially limited, as long as it has at least the above-described pressure-sensitive adhesive sheet and a base material, in which the base material includes metal wiring (e.g., copper wiring) on at least one face, and the above-described pressure-sensitive adhesive layer (optical pressure-sensitive adhesive layer according to the present invention) is attached onto the face on the side of the base material having the metal wiring. Further, although the above-described pressure-sensitive adhesive sheet may be provided with a separator on the pressure-sensitive adhesive face until usage, since the above-described pressure-sensitive adhesive sheet in the optical component according to the present invention is a pressure-sensitive adhesive sheet that is being used, it does not have a separator.

From the perspective of obtaining an even better corrosion inhibition effect, it is preferred that the optical component has the above-described pressure-sensitive adhesive layer on the opposite side to the side of the base material that has the metal wiring. More preferably, the above-described pressure-sensitive adhesive layer is attached onto the face on the opposite side to the side of the base material that has the metal wiring.

Examples of the material forming the metal wiring include, but are not especially limited to, metals such as titanium, silicon, niobium, indium, zinc, tin, gold, silver, copper, aluminum, cobalt, chromium, nickel, lead, iron, palladium, platinum, tungsten, zirconium, tantalum, and hafnium. Further examples may include a substance containing two or more of these metals, or an alloy having these metals as a main component. Among these examples, from the perspective of conductance, gold, silver, and copper are preferred, and from the perspectives of conductance and cost, copper is more preferred. Specifically, it is especially preferred that the metal wiring is copper wiring. This is also the case for the materials forming the metal wiring in the below-described touch panel.

The term “optical component” refers to a member having an optical property (e.g., a polarization property, a photorefractive property, a light scattering property, a light reflective property, a light transmitting property, a light absorbing property, a light diffractive property, an optical rotation property, visibility). Examples of the base material configuring the optical component include, but are not especially limited to, a base material configuring a device (optical device) such as display device (image display device) or an input device, or a base material used in such devices. Examples thereof may include a polarizing plate, a wave plate, a retardation plate, an optical compensation film, a brightness enhancing film, a light guide plate, a reflective film, an anti-reflective film, a hard coat film (a film subjected to a hard coat treatment on at least one side of a plastic film such as a PET film), a transparent conductive film (e.g. plastic film having an ITO layer on the surface thereof (preferably, an ITO film of PET-ITO, polycarbonate, a cycloolefin polymer etc.)), a design film, a decorative film, a surface protective film, a prism, a lens, a color filter, a transparent base material (a glass base material of a glass sensor, a glass display panel (LCD etc.), a glass plate provided with a transparent electrode etc.), as well as a base material in which these are laminated (these are sometimes collectively referred to as “a functional film”). Further, these films may also have a metal nanowire layer, a conductive polymer layer and the like. Still further, fine metal wiring may be mesh-printed on these films. The terms “plate” and “film” respectively include shapes such as a plate shape, a film shape, and a sheet shape. For example, the term “polarizing film” includes “polarizing plate” and “polarizing sheet”. In addition, the term “film” includes a film sensor.

Examples of the display device include a liquid crystal display device, an organic electroluminescence (EL) display device, a plasma display panel (PDP), and electronic paper. Further, examples of the input device include a touch panel.

Examples of the base material configuring the optical component include, but are not especially limited to, a base material (e.g., a sheet shape, film shape, or plate shape base material) formed from glass, acrylic resin, polycarbonate, polyethylene terephthalate, a cycloolefin polymer, a metal thin film or the like. As described above, the term “optical component” in the present invention also includes a member (a design film, a decorative film, a surface protective film etc.) for decoration or protection while maintaining visibility of the display device or the input device.

If the pressure-sensitive adhesive sheet according to the present invention is a pressure-sensitive adhesive sheet with a substrate, and if the pressure-sensitive adhesive sheet configures a member having optical properties, then the substrate can be viewed as being the above-described base material, so that the pressure-sensitive adhesive sheet can be said to also be the optical component according to the present invention.

If the pressure-sensitive adhesive sheet according to the present invention is a pressure-sensitive adhesive sheet with a substrate, and the above-described functional film is used as the substrate, the pressure-sensitive adhesive sheet according to the present invention can also be used as a “pressure-sensitive adhesive functional film” having the pressure-sensitive adhesive layer on at least one side of the functional film.

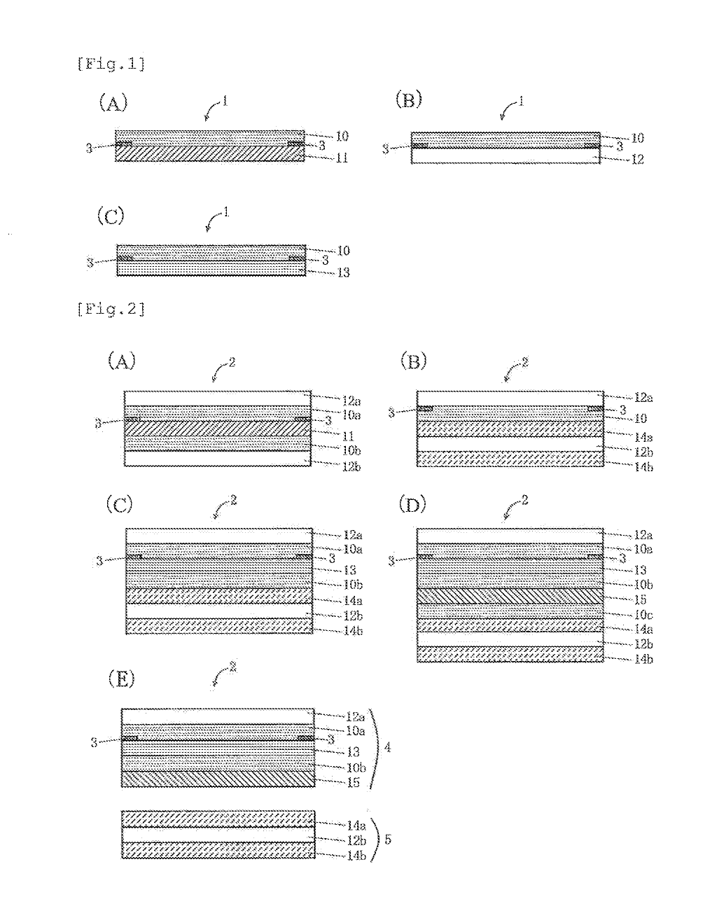

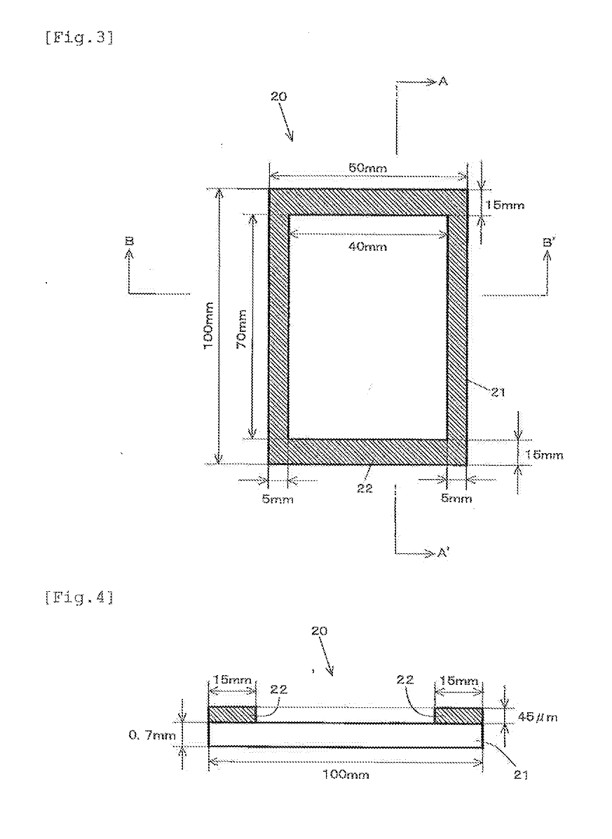

Next, specific examples of especially preferred embodiments of the optical component according to the present invention will be described with reference to the schematic diagrams of FIG. 1.

FIG. 1(A) illustrates an optical component 1 having at least a pressure-sensitive adhesive sheet 10 and a base material, which is a transparent conductive film 11. The transparent conductive film 11 includes metal wiring 3 on one face, and the pressure-sensitive adhesive sheet 10 is attached onto the face on the side of the transparent conductive film 11 that has the metal wiring 3.

FIG. 1(B) illustrates an optical component 1 having at least a pressure-sensitive adhesive sheet 10 and a base material, which is a transparent base material 12. The transparent base material 12 includes metal wiring 3 on one face, and the pressure-sensitive adhesive sheet 10 is attached onto the face on the side of the transparent base material 12 that has the metal wiring 3.

FIG. 1(C) illustrates an optical component 1 having at least a pressure-sensitive adhesive sheet 10 and base material, which is a film sensor 13. The film sensor 13 includes metal wiring 3 on one face, and the pressure-sensitive adhesive sheet 10 is attached onto the face on the side of the film sensor 13 that has the metal wiring 3.

### [4. Touch Panel]

The touch panel according to the present invention is not especially limited, as long as it has at least the above-described pressure-sensitive adhesive sheet and a base material, in which the base material includes metal wiring (e.g., copper wiring) on one face, and the above-described pressure-sensitive adhesive layer is attached onto the face on the side of the base material having the metal wiring. Further, since the above-described pressure-sensitive adhesive sheet in the touch panel according to the present invention is a pressure-sensitive adhesive sheet that is being used, it does not have a separator.

A preferred embodiment of the touch panel is a configuration in which the optical component according to the present invention is laminated with another optical component (which although may or may not have the above-described pressure-sensitive adhesive sheet, from the perspective that an even better corrosion inhibition effect is obtained, preferably does have the above-described pressure-sensitive adhesive sheet). Further, one or a plurality of this other optical component may be provided.

Examples of embodiments in the above case of the lamination of the optical component according to the present invention and another optical component may include, but are not especially limited to, (1) laminating the optical component according to the present invention with the other optical component via the pressure-sensitive adhesive sheet according to the present invention, (2) laminating the pressure-sensitive adhesive sheet according to the present invention that includes or configures an optical component to the other optical component, (3) laminating an optical component to a member other than an optical component via the pressure-sensitive adhesive sheet according to the present invention, and (4) laminating the pressure-sensitive adhesive sheet according to the present invention that includes or configures an optical component to a member other than an optical component. In the above embodiment (2), it is preferred that the pressure-sensitive adhesive sheet according to the present invention is a double-sided pressure-sensitive adhesive sheet in which the substrate is an optical component (e.g., an optical film).

Next, specific examples of especially preferred embodiments of the touch panel according to the present invention will be described with reference to the schematic diagrams of FIG. 2.

FIG. 2(A) illustrates a touch panel 2 having, in order and with each part in contact with the others, a transparent base material 12a, a pressure-sensitive adhesive sheet 10a, a transparent conductive film 11, a pressure-sensitive adhesive sheet 10b, and a transparent base material. 12b. The transparent conductive film 11 includes metal wiring 3 on the face on the pressure-sensitive adhesive sheet 10a side, and the pressure-sensitive adhesive sheet 10a is attached onto the face on the side of the transparent conductive film 11 that has the metal wiring 3. It is preferred that the transparent base materials 12a and 12b are glass, and that the transparent conductive film 11 is PET-ITO. Although the pressure-sensitive adhesive sheet 10b does not have to be the pressure-sensitive adhesive sheet according to the present invention, it is preferred that it is the pressure-sensitive adhesive sheet according to the present invention.

FIG. 2(B) illustrates a touch panel 2 having, in order and with each part in contact with the others, a transparent base material 12a, a pressure-sensitive adhesive sheet 10, a polarizing plate 14a, a transparent base material 12b, and a polarizing plate 14b. The transparent base material 12a includes metal wiring 3 on the face on the pressure-sensitive adhesive sheet 10 side, and the pressure-sensitive adhesive sheet 10 is attached onto the face on the side of the transparent base material 12a that has the metal wiring 3. It is preferred that the transparent base material 12a is a cover glass sensor, and that the transparent base material 12b is, for example, a glass display panel, such as an LCD.

FIG. 2(C) illustrates a touch panel 2 having, in order and with each part in contact with the others, a transparent base material 12a, a pressure-sensitive adhesive sheet 10a, a film sensor 13, a pressure-sensitive adhesive sheet 10b, a polarizing plate 14a, a transparent base material 12b, and a polarizing plate 14b. The film sensor 13 includes metal wiring 3 on the face on the pressure-sensitive adhesive sheet 10a side, and the pressure-sensitive adhesive sheet 10a is attached onto the face on the side of the film sensor 13 that has the metal wiring 3. It is preferred that the transparent base material 12a is glass, and that the transparent base material 12b is, for example, a glass display panel, such as an LCD. Although the pressure-sensitive adhesive sheet 10b does not have to be configured from the optical pressure-sensitive adhesive layer according to the present invention, it is preferred that it is configured from the optical pressure-sensitive adhesive layer according to the present invention.

FIG. 2(D) illustrates a touch panel 2 having, in order and with each part in contact with the others, a transparent base material 12a, a pressure-sensitive adhesive sheet 10a, a film sensor 13, a pressure-sensitive adhesive sheet 10b, a hard coat film 15, a pressure-sensitive adhesive sheet 10c, a polarizing plate 14a, a transparent base material 12b, and a polarizing plate 14b. The film sensor 13 includes metal wiring 3 on the face on the pressure-sensitive adhesive sheet 10a side, and the pressure-sensitive adhesive sheet 10a is attached onto the face on the side of the film sensor 13 that has the metal wiring 3. It is preferred that the transparent base material 12a is glass, that the transparent base material 12b is, for example, a glass display panel, such as an LCD, and that the hard coat film 15 is a hard coat PET film. Although the pressure-sensitive adhesive sheets 10b and 10c do not have to be configured from the optical pressure-sensitive adhesive layer according to the present invention, it is preferred that they are configured from the optical pressure-sensitive adhesive layer according to the present invention.

FIG. 2(E) illustrates a touch panel 2 configured from an optical component 4 having, in order and with each part in contact with the others, a transparent base material 12a, a pressure-sensitive adhesive sheet 10a, a film sensor 13, a pressure-sensitive adhesive sheet 10b, and a hard coat film 15, and an optical component 5 having, in order and with each part in contact with the others, a polarizing plate 14a, a transparent base material 12b, and a polarizing plate 14b. The optical components 4 and 5 are positioned so that the hard coat film 15 and the polarizing plate 14a are facing each other. The hard coat film 15 is not in contact with the polarizing plate 14a, an air layer is formed between the hard coat film 15 and the polarizing plate 14a. The film sensor 13 includes metal wiring 3 on the face on the pressure-sensitive adhesive sheet 10a side, and the pressure-sensitive adhesive sheet 10a is attached onto the face on the side of the film sensor 13 that has the metal wiring 3. It is preferred that the transparent base material 12a is glass, that the transparent base material 12b is, for example, a glass display panel, such as an LCD, and that the hard coat film 15 is a hard coat PET film. Although the pressure-sensitive adhesive sheets 10b and 10c do not have to be configured from the optical pressure-sensitive adhesive layer according to the present invention, it is preferred that they are configured from the optical pressure-sensitive adhesive layer according to the present invention.

Further, examples of the metal wiring pattern (wiring example of the metal wiring) include, but are not especially limited to, the metal wiring pattern illustrated in FIG. 7. FIG. 7 is a schematic plan view illustrating an example of a metal wiring pattern. In FIG. 7, reference characters 71a to 76a denote metal wiring (pattern wiring), reference characters 71b to 76b denote metal wiring (pattern wiring), and reference numerals 81 to 86 denote electrodes (transparent electrodes). Each electrode is connected to the metal wiring. For example, electrode 81 is connected to metal wiring 71a and metal wiring 71b. In addition, in FIG. 7, although the electrodes are patterned in a strip shape, the shape of the electrodes is not limited to a strip shape. Moreover, in FIG. 7, although each electrode is connected to the metal wiring at two locations, the number of connection locations of the metal wiring in the electrodes is not especially limited. For example, the electrodes may be connected to the metal wiring at one location, or connected to the metal wiring at three or more locations. Further, the metal wiring may be connected as necessary to a control means, such as an IC.

Examples of the method for forming the above-described metal wiring pattern include, but are not especially limited to, a method that uses etching or the like to remove a metal layer provided in advance, and a printing method.

### EXAMPLES

The present invention will now be described in more detail with reference to the following examples. However, the present invention is not in any way limited to the following examples.

### Acrylic Polymer Production Example 1

A four-necked flask was charged with 60 parts by weight of dicyclopentanyl methacrylate (DCPMA, dicyclopentanyl methacrylate), 40 parts by weight of methyl methacrylate (MMA), 3.5 parts by weight of α-thioglycerol as a chain transfer agent, and 100 parts by weight of toluene as a polymerization solvent, and the contents were stirred at 70° C. for one hour under a nitrogen atmosphere. Next, 0.2 parts by weight of 2,2′-azobisisobutyronitrile as a polymerization initiator was charged into the four-necked flask, and the contents were reacted at 70° C. for 2 hours, and then at 80° C. for 2 hours. The reaction solution was then placed in an atmosphere having a temperature of 130° C. to dry and remove the toluene, the chain transfer agent, and the unreacted monomers, thereby obtaining a solid acrylic polymer. The obtained acrylic polymer was designated as “acrylic polymer (B-1)”.

The acrylic polymer (B-1) had a weight average molecular weight (Mw) of 5.1×10³.

### Example 1

A monomer mixture formed from 68 parts by weight of 2-ethylhexyl acrylate (2EHA), 14.5 parts by weight of N-vinyl-2-pyrrolidone (NVP), and 17.5 parts by weight of 2-hydroxyethyl acrylate (HEA) was blended with 0.035 parts by weight of a photopolymerization initiator (trade name: “Irgacure 184”, manufactured by BASF SE) and 0.035 parts by weight of a photopolymerization initiator (trade name: “Trgacure 651”, manufactured by BASF SE). The resultant mixture was then irradiated with UV-rays until the viscosity (using a BH viscometer equipped with a No. 5 rotor at 10 rpm and a measuring temperature of 30° C.) reached about 20 Pa·s, thereby obtaining a prepolymer composition in which a part of the above-described monomer component had been polymerized.

Next, 100 parts by weight of this prepolymer composition was charged with 5 parts by weight of the above acrylic polymer (B-1), 0.075 parts by weight of hexanediol diacrylate (HDDA), 0.3 parts by weight of a silane coupling agent (trade name: “KBM-403”, manufactured by Shin-Etsu Chemical Co., Ltd.), and 0.05 parts by weight of 1,2,3-benzotriazole (trade name: “BT-120”, manufactured by Johoku Chemical Co., Ltd.). The contents were mixed to obtain a pressure-sensitive adhesive composition (pre-cured composition).

The above pressure-sensitive adhesive composition was coated on a polyethylene terephthalate (PET) separator (trade name: “MRF50”, manufactured by Mitsubishi Plastics, Inc.) such that a final thickness (thickness of the pressure-sensitive adhesive layer) was 100 μm, thereby forming a coating layer (pressure-sensitive adhesive composition layer). Next, on this coating layer, a PET separator (trade name: “MRF38”, manufactured by Mitsubishi Plastics, Inc.) was provided to cover the coating layer and block oxygen, whereby a MRF50/coating layer (pressure-sensitive adhesive composition layer)/MRF38 laminate was obtained.

Next, this laminate was irradiated for 300 seconds with UV-rays at an illuminance of 5 mW/cm² from the upper face (MRF38 side) of the laminate by a black light (manufactured by Toshiba Corporation). Further, a drying treatment was carried out for 2 minutes in a dryer at 90° C. to evaporate the residual monomers. Then, a substrateless double-sided pressure-sensitive adhesive sheet formed from only the pressure-sensitive adhesive layer, in which both faces of the pressure-sensitive adhesive layer were protected by a separator, was obtained.

### Example 2

A substrateless double-sided pressure-sensitive adhesive sheet was obtained in the same manner as Example 1, except that the amount of 1,2,3-benzotriazole used was changed to 0.1 parts by weight.

### Example 3

A substrateless double-sided pressure-sensitive adhesive sheet was obtained in the same manner as Example 1, except that the amount of 1,2,3-benzotriazole used was changed to 0.2 parts by weight.

### Example 4

A substrateless double-sided pressure-sensitive adhesive sheet was obtained in the same manner as Example 1, except that the amount of 1,2,3-benzotriazole used was changed to 0.3 parts by weight and the thickness of the pressure-sensitive adhesive layer was changed to 50 μm.

### Example 5

A substrateless double-sided pressure-sensitive adhesive sheet was obtained in the same manner as Example 1, except that the amount of 1,2,3-benzotriazole used was changed to 0.3 parts by weight.

### Example 6

A substrateless double-sided pressure-sensitive adhesive sheet was obtained in the same manner as Example 1, except that the amount of 1,2,3-benzotriazole used was changed to 0.3 parts by weight and the thickness of the pressure-sensitive adhesive layer was changed to 150 μm.

### Example 7

A substrateless double-sided pressure-sensitive adhesive sheet was obtained in the same manner as Example 1, except that the amount of 1,2,3-benzotriazole used was changed to 0.3 parts by weight and the thickness of the pressure-sensitive adhesive layer was changed to 250 μm.

### Example 8

A substrateless double-sided pressure-sensitive adhesive sheet was obtained in the same manner as Example 1, except that the amount of 1,2,3-benzotriazole used was changed to 0.5 parts by weight.

### Example 9

A substrateless double-sided pressure-sensitive adhesive sheet was obtained in the same manner as Example 1, except that the amount of 1,2,3-benzotriazole used was changed to 2.0 parts by weight.

### Example 10

A substrateless double-sided pressure-sensitive adhesive sheet was obtained in the same manner as Example 1, except that 0.5 parts by weight of 5-methylbenzotriazole (trade name: “5M-BTA”, manufactured by Johoku Chemical Co., Ltd.) was used instead of the 1,2,3-benzotriazole.

### Example 11

A substrateless double-sided pressure-sensitive adhesive sheet was obtained in the same manner as Example 1, except that 0.5 parts by weight of 1-[N,N-bis(2-ethylhexyl)aminomethyl]benzotriazole (trade name: “BT-LX”, manufactured by Johoku Chemical Co., Ltd.) was used instead of the 1,2,3-benzotriazole.

### Example 12

A substrateless double-sided pressure-sensitive adhesive sheet was obtained in the same manner as Example 1, except that 0.5 parts by weight of 1-[N,N-bis(2-ethylhexyl)aminomethyl]methylbenzotriazole (trade name: “TT-LX”, manufactured by Johoku Chemical Co., Ltd.) was used instead of the 1,2,3-benzotriazole.

### Example 13

A substrateless double-sided pressure-sensitive adhesive sheet was obtained in the same manner as Example 1, except that the amount of 1,2,3-benzotriazole used was changed to 0.3 parts by weight, the composition of the above-described monomer mixture was changed to 61 parts by weight of 2-ethylhexyl acrylate (2EHA), 14 parts by weight of N-vinyl-2-pyrrolidone (NVP), and 25 parts by weight of 4-hydroxybutyl acrylate (4HBA), and the amount of hexanediol diacrylate (HDDA) was changed to 0.060 parts by weight.

### Example 14

A substrateless double-sided pressure-sensitive adhesive sheet was obtained in the same manner as Example 1, except that the amount of 1,2,3-benzotriazole used was changed to 5.0 parts by weight.

### Example 15

A substrateless double-sided pressure-sensitive adhesive sheet was obtained in the same manner as Example 1, except that the amount of 1,2,3-benzotriazole used was changed to 0.5 parts by weight, the acrylic polymer (B-1) was not used, and the composition of the above-described monomer mixture was changed to 78 parts by weight of 2-ethylhexyl acrylate (2EHA), 18 parts by weight of N-vinyl-2-pyrrolidone (NVP), and 4 parts by weight of 2-hydroxyethyl acrylate (HEA).

### Example 16

A pressure-sensitive adhesive composition (pre-curing composition) was obtained in the same manner as Example 1, except that the amount of hexanediol diacrylate (HDDA) was changed to 0.250 parts by weight, and the amount of 1,2,3-benzotriazole (trade name: “BT-120”, manufactured by Johoku Chemical Co., Ltd.) was changed to 0.3 parts by weight.

Then, using this composition, a substrateless double-sided pressure-sensitive adhesive sheet formed only from a pressure-sensitive adhesive layer and in which both faces of the pressure-sensitive adhesive layer were protected by a separator was obtained in the same manner as Example 1.

### Example 17

A prepolymer composition in which a part of the above-described monomer component was polymerized was obtained in the same manner as Example 1, except that a monomer mixture formed from 61 parts by weight of 2-ethylhexyl acrylate (2EHA), 14 parts by weight of N-vinyl-2-pyrrolidone (NVP), 3 parts by weight of 2-hydroxyethyl acrylate (HEA), and 22 parts by weight of 4-hydroxybutyl acrylate (4HBA) was used.

Next, 100 parts by weight of this prepolymer composition was charged with 0.180 parts by weight of hexanediol diacrylate (HDDA), 0.3 parts by weight of a silane coupling agent (trade name: “KBM-403”, manufactured by Shin-Etsu Chemical Co., Ltd.), and 0.3 parts by weight of 1,2,3-benzotriazole (trade name: “BT-120”, manufactured by Johoku Chemical Co., Ltd.). The contents were mixed to obtain a pressure-sensitive adhesive composition (pre-curing composition).

Then, using this pressure-sensitive adhesive composition, a substrateless double-sided pressure-sensitive adhesive sheet formed only from a pressure-sensitive adhesive layer and in which both faces of the pressure-sensitive adhesive layer were protected by a separator was obtained in the same manner as Example 1.

### Example 18

A prepolymer composition in which a part of the above-described monomer component was polymerized was obtained in the same manner as Example 1, except that a monomer mixture formed from 61 parts by weight of 2-ethylhexyl acrylate (2EHA), 14 parts by weight of N-vinyl-2-pyrrolidone (NVP), 3 parts by weight of 2-hydroxyethyl acrylate (HEA), and 22 parts by weight of 4-hydroxybutyl acrylate (4HBA) was used.

Next, 100 parts by weight of this prepolymer composition was charged with 0.060 parts by weight of hexanediol diacrylate (HDDA), 0.3 parts by weight of a silane coupling agent (trade name: “KBM-403”, manufactured by Shin-Etsu Chemical Co., Ltd.), and 0.3 parts by weight of 1,2,3-benzotriazole (trade name: “BT-120”, manufactured by Johoku Chemical Co., Ltd.). The contents were mixed to obtain a pressure-sensitive adhesive composition (pre-curing composition).

Then, using this composition, a substrateless double-sided pressure-sensitive adhesive sheet formed only from a pressure-sensitive adhesive layer and in which both faces of the pressure-sensitive adhesive layer were protected by a separator was obtained in the same manner as Example 1.

### Comparative Example 1

A substrateless double-sided pressure-sensitive adhesive sheet was obtained in the same manner as Example 1, except that 1,2,3-benzotriazole was not used.

### Comparative Example 2

A substrateless double-sided pressure-sensitive adhesive sheet was obtained in the same manner as Example 1, except that 0.5 parts by weight of pentaerythritol tetrakis[3-(3,5-di-tert-butyl-4-hydroxyphenyl)propionate](trade name: “Irganox 1010”, manufactured by BASF SE) was used instead of the 1,2,3-benzotriazole.

### Comparative Example 3

A substrateless double-sided pressure-sensitive adhesive sheet was obtained in the same manner as Example 1, except that 1,2,3-benzotriazole was not used, the acrylic polymer (B-1) was not used, the composition of the above-described monomer mixture was changed to 90 parts by weight of 2-ethylhexyl acrylate (2EHA) and 10 parts by weight of acrylic acid (AA), and 0.070 parts by weight of dipentaerythritol hexaacrylate (DPHA) was used instead of the 0.075 parts by weight of hexanediol diacrylate (HDDA).

### Comparative Example 4

A substrateless double-sided pressure-sensitive adhesive sheet was obtained in the same manner as Example 1, except that the amount of 1,2,3-benzotriazole used was changed to 0.5 parts by weight, the acrylic polymer (B-1) was not used, the composition of the above-described monomer mixture was changed to 90 parts by weight of 2-ethylhexyl acrylate (2EHA) and 10 parts by weight of acrylic acid (AA), and 0.070 parts by weight of dipentaerythritol hexaacrylate (DPHA) was used instead of the 0.075 parts by weight of hexanediol diacrylate (HDDA).

### Comparative Example 5

A prepolymer composition in which a part of the above-described monomer component was polymerized was obtained in the same manner as Example 1, except that a monomer mixture formed from 60 parts by weight of lauryl acrylate (LA), 22 parts by weight of 2-ethylhexyl acrylate (2EHA), 10 parts by weight of N-vinyl-2-pyrrolidone (NVP), and 8 parts by weight of 4-hydroxybutyl acrylate (4HBA) was used.

Next, 100 parts by weight of this prepolymer composition was charged with 0.035 parts by weight of dipentaerythritol hexaacrylate (DPHA) and 0.3 parts by weight of a silane coupling agent (trade name: “KBM-403”, manufactured by Shin-Etsu Chemical Co., Ltd.). The contents were mixed to obtain a pressure-sensitive adhesive composition (pre-curing composition).

Then, using this composition, a substrateless double-sided pressure-sensitive adhesive sheet formed only from a pressure-sensitive adhesive layer and in which both faces of the pressure-sensitive adhesive layer were protected by a separator was obtained in the same manner as Example 1.

### Comparative Example 6

A substrateless double-sided pressure-sensitive adhesive sheet was obtained in the same manner as Example 1, except that the amount of the 1,2,3-benzotriazole used was changed to 0.3 parts by weight, the composition of the above-described monomer mixture was changed to 60 parts by weight of lauryl acrylate (LA), 22 parts by weight of 2-ethylhexyl acrylate (2EHA), 10 parts by weight of N-vinyl-2-pyrrolidone (NVP), and 8 parts by weight of 4-hydroxybutyl acrylate (4HBA), and 0.035 parts by weight of dipentaerythritol hexaacrylate (DPHA) was used instead of the 0.075 parts by weight of hexanediol diacrylate (HDDA).

### [Properties Evaluation]

The substrateless double-sided pressure-sensitive adhesive sheets of the examples and the comparative examples were subjected to the following measurements or evaluations. The results are shown in Table 2.

### (1) Metal Corrosion

One of the separators of the double-sided pressure-sensitive adhesive sheet was peeled off on the substrate face side of a film, in which a copper layer had been provided on one face of a cycloolefin (COP) substrate (trade name: “Zeonor”, manufactured by Nippon Zeon Corporation, thickness: 100 μm) (hereinafter sometimes referred to as “copper film”), and the double-sided pressure-sensitive adhesive sheet was then pressure-bonded and laminated by moving a 2-kg roller back and forth once to obtain a structure A having a laminated structure of the copper film and the double-sided pressure-sensitive adhesive sheet.

Next, the structure A was cut to a 15 mm×15 mm size, the separator of the double-sided pressure-sensitive adhesive sheet was peeled off, and the structure A was then pressure-bonded and laminated onto a soda glass plate (25 mm×25 mm, thickness 0.7 mm) by moving a 2-kg roller back and forth once to obtain a structure B having a laminated structure of the copper film, the double-sided pressure-sensitive adhesive sheet, and glass.

Separately, one of the separators of a double-sided pressure-sensitive adhesive sheet identical with that described above was peeled off the substrate face side of a film, in which an antireflection treatment layer had been provided on one face of a triacetyl cellulose (TAC) substrate (trade name: “DSC-03”, manufactured by Dai Nippon Printing Co., Ltd., thickness: 90 μm, hereinafter sometimes referred to as “AR film”), and the double-sided pressure-sensitive adhesive sheet was then pressure-bonded and laminated by moving a 2-kg roller back and forth once to obtain a structure C having a laminated structure of the AR film and the double-sided pressure-sensitive adhesive sheet. Next, the structure C was cut to a 10 mm×10 mm size, the separator of the double-sided pressure-sensitive adhesive sheet was then peeled off, and the structure C was pressure-bonded and laminated onto the center portion on the copper face side of the structure B by moving a 2-kg roller back and forth once to obtain a structure D having a five-layer laminated structure of the AR film, the double-sided pressure-sensitive adhesive sheet, the copper film, the double-sided pressure-sensitive adhesive sheet, and glass.

The structure D was left for 30 minutes under a 23° C., 50% RH atmosphere, then placed in an autoclave, and subjected to an autoclave treatment for 15 minutes under a temperature of 50° C. and a pressure of 0.5 MPa. The treated structure D was removed from the autoclave, and then left for 24 hours under a 23° C., 50% RH(RH: relative humidity) atmosphere.

As the apparatus for measuring the sheet resistance value of the copper layer of the structure D, a Hall effect measurement apparatus (trade name: “HL 5500PC”, manufactured by Toho Technology Corporation) was used. Each sheet resistance value (initial sheet resistance: R₀) of the structure D was measured under a 23° C., 50% RH atmosphere.

After measurement, to prevent oxidation of the copper touching the measurement probe, each structure D was placed for 300 hours under a 85° C., 85° RH environment with the surface of the copper on which the AR film was not laminated covered. After being removed, the temperature and humidity were adjusted for 24 hours under a 23° C., 50% RH environment. The change in the color of the copper from the initial stage was respectively visually confirmed, and then the sheet resistance value (after-testing sheet resistance: R₁) was respectively measured under a 23° C., 50% RH atmosphere.

The rate of change T in the sheet resistance value was determined based on the following calculation formula from the initial sheet resistance value (R₀) and the after-testing sheet resistance value (R₁) after having been placed for 300 hours under a 85° C., 85° RH environment.

Rate of change T (%)=(R₁−R₀)/R₀×100

If the rate of change T in the sheet resistance value was less than 150%, the sheet was evaluated as a pass “◯” and as having a good corrosion inhibition performance. On the other hand, if the rate of change in the sheet resistance value from the initial stage was not less than 150%, the sheet was evaluated as a fail “x” and as not having a good corrosion inhibition performance.

### (2) Total Light Transmittance and Haze

One of the separators was peeled from a double-sided pressure-sensitive adhesive sheet, and this double-sided pressure-sensitive adhesive sheet was laminated on a slide glass (manufactured by Matsunami Glass Ind. Ltd., “White Polish No. 1”, thickness 0.8 to 1.0 mm, total light transmittance 92%, and haze 0.2%). Then, the other separator was peeled off to produce a test piece having a double-sided pressure-sensitive adhesive sheet (pressure-sensitive adhesive layer)/slide glass layer structure.

The total light transmittance and the haze in the visible light region of the above test piece were measured using a haze meter (apparatus name: “HM-150”, manufactured by Murakami Color Research Laboratory Co., Ltd.).

### (3) 180° Peel Adhesive Strength (180° Peel Adhesive Strength to a Glass Plate)

A sheet piece having a length of 100 mm and a width of 20 mm was cut out from the double-sided pressure-sensitive adhesive sheet. Next, one of the separators was peeled off from the sheet piece, and the resulting sheet piece was laminated to (backed with) a PET film (trade name: “Lumirror S-10”, thickness: 25 μm, manufactured by Toray Industries, Inc.). Then, the other separator was peeled off, and the resulting laminate was pressure-bonded to a test plate by moving a 2-kg roller back and forth once and then aged under a 23° C., 50% RH atmosphere for 30 minutes. After the aging, the pressure-sensitive adhesive sheet was peeled off from the test plate using a tensile tester (apparatus name: “Autograph AG-IS”, manufactured by Shimadzu Corporation) under a 23° C., 50% RH atmosphere at a tensile speed of 300 mm/min and a peel angle of 180° based on JIS Z0237, and the 180° peel adhesive strength (N/20 mm) was measured.

As the test plate, a glass plate (trade name: “Soda Lime Glass #0050”, manufactured by Matsunami Glass Ind. Ltd.) was used.

### (4) Humid Cloudiness Resistance

A double-sided pressure-sensitive adhesive sheet was cut to a size having a width of 45 mm and a length of 90 mm, one of the separators was then peeled off, and the double-sided pressure-sensitive adhesive sheet was pressure-bonded and laminated on a soda glass plate (manufactured by Matsunami Glass Ind. Ltd., 100 mm×50 mm, thickness 0.7 mm) by moving a 2-kg roller back and forth once. Next, the separator was peeled off the above-described laminated double-sided pressure-sensitive adhesive sheet, and a glass plate the same as that described above was laminated thereon with a vacuum lamination apparatus at a surface pressure of 0.2 MPa, a degree of vacuum of 30 Pa, and a lamination time of 10 seconds, to obtain an evaluation sample having a glass/double-sided pressure-sensitive adhesive sheet/glass structure.

Next, the evaluation sample was placed in an autoclave, and subjected to an autoclave treatment for 15 minutes under a temperature of 50° C. and a pressure of 0.5 MPa. The treated evaluation sample was then removed from the autoclave, and left for 24 hours under a 23° C., 50% RH (RH: relative humidity) atmosphere.

The evaluation sample was placed under a 60° C., 95% RH high-temperature, high-humidity environment for 300 hours. Then, the evaluation sample was removed from that environment, and left for 24 hours under a 23° C., 50% RH environment. The appearance of the evaluation sample was then visually observed to evaluate humid cloudiness resistance based on the following evaluation criteria.

### Evaluation Criteria

A: No whitening
B: Whitening seen only at the four corners of the double-sided pressure-sensitive adhesive sheet
C: Whitening seen on the whole face of the double-sided pressure-sensitive adhesive sheet

### (5) Resistance to Foaming and Release

One of the separators of the double-sided pressure-sensitive adhesive sheet was peeled off, and the double-sided pressure-sensitive adhesive sheet was pressure-bonded and laminated to the face on the ITO layer side of a film in which an ITO (oxide of indium and tin) layer had been provided on one face of a cycloolefin (COP) substrate (trade name: “Zeonor”, manufactured by Nippon Zeon Corporation, thickness: 100 μm) (hereinafter sometimes referred to as “COP-ITO film”) by moving a 2-kg roller back and forth once, whereby a structure A′ having a laminated structure of the COP-ITO film and the double-sided pressure-sensitive adhesive sheet was obtained.

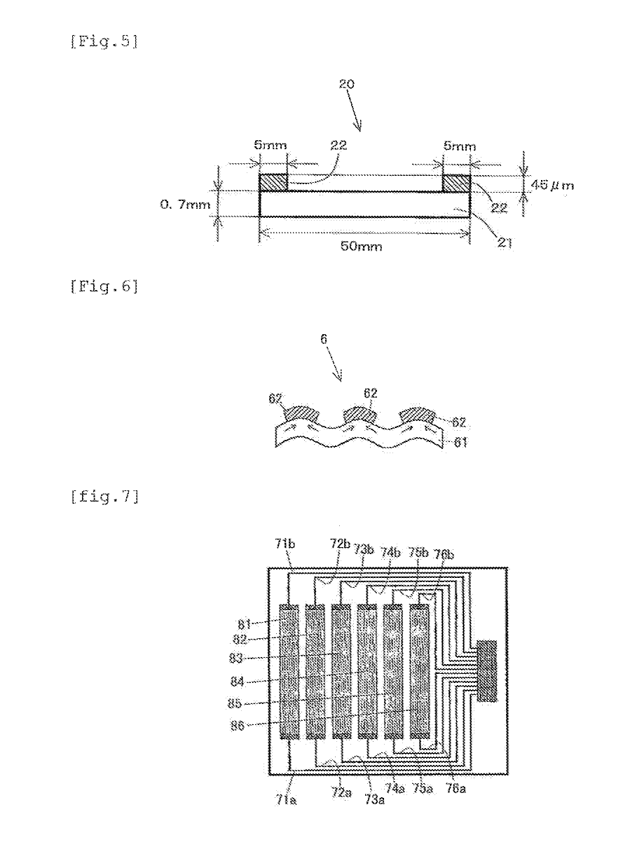

Next, the separator of the double-sided pressure-sensitive adhesive sheet in the structure A′ was peeled off, and the structure A′ was pressure-bonded and laminated to the face of a glass with a step (see FIGS. 4 to 6), on the side where the step was present, by moving a 2-kg roller back and forth once, whereby structure B′ having a laminated structure of the COP-ITO film, the double-sided pressure-sensitive adhesive sheet, and the glass with a step, was obtained.

The structure B′ was left for 1 hour under a 23° C., 50% RH atmosphere, then placed in an autoclave, and subjected to an autoclave treatment for 15 minutes under a temperature of 50° C. and a pressure of 0.5 MPa. The treated structure B′ was then removed from the autoclave, placed into a dryer set up at 85° C., and left for 24 hours.

The structure B′ was then removed from the dryer and left for 30 minutes under a 23° C., 50% RH atmosphere. The presence of foaming (foaming including bubbles caused by extraneous materials) and peeling in the structure B′ was verified with a microscope. The structure B′ was then evaluated based on the following evaluation criteria.

### Evaluation Criteria

A: No foaming or peeling at all
B: Foaming caused by only extraneous materials having a size of not less than 100 μm observed
C: Foaming caused by extraneous materials having a size of less than 100 μm observed
D: Foaming and peeling observed regardless of the presence of extraneous materials

The evaluation of the resistance to foaming and release performed in the above (5) was also carried out on a film in which an ITO (oxide of indium and tin) layer had been provided on one face of a polyethylene terephthalate (PET) substrate (thickness: 50 μm) (hereinafter sometimes referred to as “PET-ITO film”) instead of the COP-ITO film.

### (6) Visual Evaluation of Pattern

An ITO film (ITO layer) having a thickness of 22 nm was deposited by a sputtering method on one face of a film substrate (a biaxially-stretched polyethylene terephthalate (PET) film having a thickness of 23 μm, trade name “Diafoil”, manufactured by Mitsubishi Plastics Inc.) to obtain a film (ITO film) having an ITO film formed on one face of the film substrate.

Next, this ITO film was cut into a sheet shape having a width of 6 cm and a length of 10 cm. A plurality of pieces of polyimide tape having a width of 2 mm were laminated at 2 mm intervals on the surface of the cut ITO film. The lamination of the polyamide tape was carried out so that the length direction of the polyamide tape and the width direction of the cut ITO film were in the same direction. After laminating the polyimide tape, the formed laminate was dipped for 10 minutes in a 5 wt. % aqueous hydrochloric acid solution that had been heated to 50° C. This dipping corresponds to an etching treatment carried out to remove the ITO film at the non-masked portions (portions where the polyimide tape was not laminated). After the dipping in the 5 wt. % aqueous hydrochloric acid solution, the laminate was washed with water by being dipped in a sufficient amount of pure water, and the polyimide tape was slowly peeled off.

Then, the laminate was heated for 5 minutes in a 70° C. oven and dried to obtain a film (ITO-patterned film) having a patterned ITO film.

This ITO-patterned film has a pattern-forming portion where the ITO film has been formed, and a pattern-free portion where the ITO film has been removed.

After providing copper wiring to connect the peripheral portion of the face of the ITO-patterned film on which the ITO pattern was formed and the terminal portion of each pattern from the peripheral portion, a glass plate was laminated via a double-sided pressure-sensitive adhesive sheet on this face to obtain a test piece (a laminate having a laminated structure of a glass plate/double-sided pressure-sensitive adhesive sheet/ITO-patterned film provided with copper wiring).

The copper wiring provided so as to connect the peripheral portion of the face of the ITO-patterned film on which the ITO pattern was formed and the terminal portion of each pattern from the peripheral portion is the same as the state illustrated in FIG. 7.

Next, the test piece was left for 48 hours under an 85° C., 85% RH environment. The appearance of that test piece was visually confirmed and evaluated based on the following evaluation criteria.

### Evaluation Criteria

Very Good (⊚): Difficult to distinguish between the pattern-forming portion and the pattern-free portion, and the pattern can hardly be seen.
Good (◯): Possible to slightly distinguish between the pattern-forming portion and the pattern-free portion, and the pattern is somewhat visible.
Poor (x): Possible to clearly distinguish between the pattern-forming portion and the pattern-free portion, and the pattern is clearly visible.

TABLE 2

| | | | | | | | | | Adhesive | | | | |
|---|---|---|---|---|---|---|---|---|---|---|---|---|---|
| | | | | | | | Total | | Strength | | | | |
| | | 85° C. | | Metal Corrosion | | | Light | | With | | Resistance to Foaming | | |
| | | Modulus of | Thick- | | Rate of Change | | Transmit- | | Respect | Humid | and Release | | Visual |
| | | Elasticity | ness | Visual | in Sheet | Determin- | tance | Haze | to Glass | Cloudiness | COP | PET | Evaluation |
| | Special Instruction | [Pa] | [μm ] | Observation | Registivity [%] | ation | [%] | [%] | [N/20 mm] | Resistance | Substrate | Substrate | of Pattern |
| Example | | | | | | | | | | | | | |
| 1 | BT-120 0.05 parts by weight | 7.8 × 10⁴ | 100 | No discoloration | 126 | ○ | 92.2 | 0.5 | 17 | A | A | A | ○ |
| 2 | BT-120 0.1 parts by weight | 7.8 × 10⁴ | 100 | No discoloration | 123 | ○ | 92.2 | 0.5 | 17 | A | A | A | ○ |
| 3 | BT-120 0.2 parts by weight | 7.8 × 10⁴ | 100 | No discoloration | 125 | ○ | 92.2 | 0.5 | 18 | A | A | A | ○ |
| 4 | BT-120 0.3 parts by weight | 7.8 × 10⁴ | 50 | No discoloration | 123 | ○ | 92.2 | 0.3 | 13 | A | A | A | ○ |
| 5 | BT-120 0.3 parts by weight | 7.8 × 10⁴ | 100 | No discoloration | 116 | ○ | 92.2 | 0.4 | 18 | A | A | A | ○ |
| 6 | BT-120 0.3 parts by weight | 7.8 × 10⁴ | 150 | No discoloration | 112 | ○ | 92.2 | 0.4 | 20 | A | A | A | ○ |
| 7 | BT-120 0.3 parts by weight | 7.8 × 10⁴ | 250 | No discoloration | 111 | ○ | 92.2 | 0.5 | 22 | A | A | A | ○ |
| 8 | BT-120 0.05 parts by weight | 7.8 × 10⁴ | 100 | No discoloration | 115 | ○ | 92.2 | 0.6 | 20 | A | A | A | ○ |
| 9 | BT-120 2 parts by weight | 7.8 × 10⁴ | 100 | No discoloration | 122 | ○ | 92.2 | 0.7 | 18 | A | B | A | ○ |
| 10 | 5M-BTA 0.5 parts by weight | 7.8 × 10⁴ | 100 | No discoloration | 117 | ○ | 92.2 | 0.8 | 18 | A | A | A | ○ |
| 11 | BT-LX 0.5 parts by weight | 7.8 × 10⁴ | 100 | No discoloration | 137 | ○ | 92.2 | 0.7 | 18 | A | A | A | ○ |
| 12 | TT-LX 0.5 parts by weight | 7.8 × 10⁴ | 100 | No discoloration | 129 | ○ | 92.2 | 0.7 | 18 | A | A | A | ○ |
| 13 | NVP 14 parts per weight | 6.6 × 10⁴ | 100 | No discoloration | 135 | ○ | 92.3 | 0.6 | 15 | A | B | A | ○ |
| | 4HBA 25 parts by weight | | | | | | | | | | | | |
| 14 | BT-120 5 parts by weight | 7.8 × 10⁴ | 100 | No discoloration | 131 | ○ | 92.2 | 1.1 | 18 | A | C | A | ○ |
| 15 | HEA 4 parts by weight | 6.0 × 10⁴ | 100 | No discoloration | 117 | ○ | 92.2 | 0.5 | 15 | C | C | A | ○ |
| 16 | 2EHA/NVP/HEA = 67/14.5/17.5 | 1.2 × 10⁵ | 100 | No discoloration | 113 | ○ | 92.2 | 0.4 | 16 | A | B | A | ⊚ |
| | HDDA 0.250 parts by weight | | | | | | | | | | | | |
| 17 | 2EHA/NVP/HEA/4HBBA = 61/14/3/22 | 9.4 × 10⁴ | 100 | No discoloration | 121 | ○ | 92.2 | 0.7 | 13 | A | B | A | ⊚ |
| | HDDA 0.180 parts by weight | | | | | | | | | | | | |
| 18 | 2EHA/NVP/HEA/4HBBA = 61/14/3/22 | 7.1 × 10⁴ | 100 | No discoloration | 119 | ○ | 92.2 | 0.7 | 14 | A | B | A | ○ |
| | HDDA 0.060 parts by weight | | | | | | | | | | | | |
| Comparative | | | | | | | | | | | | | |
| Example | | | | | | | | | | | | | |
| 1 | No BTA | 7.8 × 10⁴ | 100 | Discoloration | 281 | X | 92.2 | 0.5 | 17 | A | A | A | ○ |
| 2 | Irganox1010 0.5 parts by weight | 7.8 × 10⁴ | 100 | Discoloration | 343 | X | 92.2 | 0.8 | 19 | A | A | A | ○ |
| 3 | Acid present, No BTA | 6.6 × 10⁴ | 100 | Discoloration | 414 | X | 92.3 | 0.4 | 17 | B | D | B | ○ |
| 4 | Acid present, BTA present | 6.6 × 10⁴ | 100 | Discoloration | 274 | X | 92.3 | 0.5 | 19 | B | D | B | ○ |
| 5 | LA/2EHA/NVP/4HBA = 60/22/10/8 | 2.2 × 10⁴ | 100 | Discoloration | 285 | X | 92.3 | 0.3 | 9 | A | B | B | X |
| | DPHA 0.035 parts by weight | | | | | | | | | | | | |
| 6 | LA/2EHA/NVP/4HBA = 60/22/10/8 | 2.2 × 10⁴ | 100 | No discoloration | 122 | ○ | 92.3 | 0.3 | 9 | A | B | B | X |
| | DPHA 0.035 parts by weight, No BTA | | | | | | | | | | | | |

### INDUSTRIAL APPLICABILITY

The optical pressure-sensitive adhesive layer according to the present invention can exhibit adhesion reliability, transparency, and a corrosion inhibition effect, can suppress the occurrence of undulations under a high-temperature environment, and can reduce the number of processes because a protective layer does not need to be coated. Consequently, costs are decreased and yield is improved. Therefore, the optical pressure-sensitive adhesive layer according to the present invention is useful for a display device, such as a liquid crystal displays (LCD), and an input device, such as a touch panel, and especially for a touch panel application.

### REFERENCE SIGNS LIST

1, 4, 5 Optical Component
2 Touch Panel
3 Metal Wiring
10, 10a, 10b, 10c Pressure-Sensitive Adhesive Sheet
11 Transparent Conductive Film
12a, 12b Transparent Base Material
13 Film Sensor
14a, 14b Polarizing Plate
15 Hard Coat Film
20 Glass With a Step (Step Test Piece)
21 Glass Plate
22 Step
6 Laminate
61 Support
62 Metal Film
71a, 72a, 73a, 74a, 75a, 76a Metal Wiring (Pattern Wiring)
71b, 72b, 73b, 74b, 75b, 76b Metal Wiring (Pattern Wiring)
81, 82, 83, 84, 85, 86 Electrode (Transparent Electrode)

1. An optical pressure-sensitive adhesive layer comprising a base polymer and a rust inhibitor, characterized in that the base polymer does not or substantially does not contain an acid group-containing monomer as a constituent monomer component, and that an 85° C. modulus of elasticity is not less than 5.0×10⁴ Pa.

2. An optical pressure-sensitive adhesive layer comprising an acrylic polymer (A) and a rust inhibitor, characterized in that the acrylic polymer (A) does not or substantially does not contain a carboxyl group-containing monomer as a constituent monomer component, and that an 85° C. modulus of elasticity is not less than 5.0×10⁴ Pa.

3. The optical pressure-sensitive adhesive layer according to claim 2, comprising not less than 5 parts by weight of a hydroxyl group-containing monomer based on a total amount (100 parts by weight) of the monomer component forming the acrylic polymer (A).

4. The optical pressure-sensitive adhesive layer according to claim 2, comprising not less than 5 parts by weight of a nitrogen atom-containing monomer based on a total amount (100 parts by weight) of the monomer component forming the acrylic polymer (A).

5. The optical pressure-sensitive adhesive layer according to claim 1, wherein the rust inhibitor is a benzotriazole-based compound.

6. The optical pressure-sensitive adhesive layer according to claim 1, wherein haze (based on JIS K7136) is not more than 1.0%.

7. The optical pressure-sensitive adhesive layer according to claim 1, wherein total light transmittance (based on JIS K7361-1) is not less than 90%.

8. A pressure-sensitive adhesive sheet comprising the optical pressure-sensitive adhesive layer according to claim 1.

9. The pressure-sensitive adhesive sheet according to claim 8, wherein a 180° peel adhesive strength to a glass plate is not less than 8 N/20 mm.

10. The pressure-sensitive adhesive sheet according to claim 8, wherein a thickness is 12 to 350 μm.

11. An optical component comprising at least the pressure-sensitive adhesive sheet according to claim 8 and a base material, wherein the base material includes metal wiring on at least one face, and the pressure-sensitive adhesive sheet is attached onto a face on the side of the base material having the metal wiring.

12. The optical component according to claim 11, wherein the metal wiring is copper wiring.

13. A touch panel comprising at least the pressure-sensitive adhesive sheet according to claim 8 and a base material, wherein the base material includes metal wiring on at least one face, and the pressure-sensitive adhesive sheet is attached onto a face on the side of the base material having the metal wiring.

14. The touch panel according to claim 13, wherein the metal wiring is copper wiring.

15. The optical pressure-sensitive adhesive layer according to claim 3, comprising not less than 5 parts by weight of a nitrogen atom-containing monomer based on a total amount (100 parts by weight) of the monomer component forming the acrylic polymer (A).

16. The optical pressure-sensitive adhesive layer according to claim 2, wherein the rust inhibitor is a benzotriazole-based compound.

17. The optical pressure-sensitive adhesive layer according to claim 2, wherein haze (based on JIS K7136) is not more than 1.0%.

18. The optical pressure-sensitive adhesive layer according to claim 2, wherein total light transmittance (based on JIS K7361-1) is not less than 90%.

19. A pressure-sensitive adhesive sheet comprising the optical pressure-sensitive adhesive layer according to claim 2.

20. The pressure-sensitive adhesive sheet according to claim 9, wherein a thickness is 12 to 350 μm.
